(19) United States
(12) Patent Application Publication
(10) Pub. No.: US 2025/0392878 A1
(43) Pub. Date: Dec. 25, 2025

(54) SIMILARITY METRIC-BASED MULTI-LISTENING POSITION AUDIO SYSTEM OPTIMIZATION

(71) Applicant: HARMAN BECKER AUTOMOTIVE SYSTEMS GmbH, Karlsbad-Ittersbach (DE)

(72) Inventors: Christopher OATES, Bamberg (DE); Adrian VON DEM KNESEBECK, Munich (DE); Martin OLSEN, Struer (DE); Friedrich VON TÜRCKHEIM, Hamburg (DE)

(21) Appl. No.: 19/208,998

(22) Filed: May 15, 2025

(30) Foreign Application Priority Data
Jun. 25, 2024 (EP) 24184257.4

(51) Int. Cl. H04S 7/00; H04S 5/00

(52) U.S. Cl. CPC H04S 7/302; H04S 5/00; H04S 7/307

(57) ABSTRACT

A computer-implemented method for determining audio signal processing parameters for a multi-channel audio system including a plurality of speakers is disclosed. The method involves obtaining at least one first audio response at a first listening position and at least one second audio response at a second listening position, where each audio response corresponds to a respective channel audio signal output by a respective speaker over a predetermined frequency range. The audio signal processing parameters are determined based on a similarity metric calculated between the first and second audio responses over at least a part of the predetermined frequency range. The determined audio signal processing parameters are then provided for further processing of at least one of the channel audio signals, enabling optimization of the audio system's performance across multiple listening positions.

### CROSS-REFERENCE TO RELATED APPLICATIONS

This application claims priority benefit to European Patent Application Number 24184257.4, entitled “SIMILARITY METRIC-BASED MULTI-LISTENING POSITION AUDIO SYSTEM OPTIMIZATION”, filed Jun. 25, 2024, the contents of which are incorporated by reference herein in its entirety.

### BACKGROUND

### Field of the Various Embodiments

Various examples of the disclosure generally relate to the field of multi-channel audio systems. Various examples of the disclosure specifically relate to determining audio signal processing parameters for a multi-channel audio system with multiple listening positions.

### Description of the Related Art

In multi-channel audio systems, achieving a balanced frequency response, in particular a balanced bass response, across multiple listening positions is a significant challenge. This is particularly evident in environments such as car audio systems, where the contributions from multiple speakers interact differently at each seat location, resulting in different frequency responses for listeners in different locations, further adapting different listening poses.

Manually tuning the various audio signal processing parameters to optimize the frequency responses across all listening positions is a complex and time-consuming task. In a typical car audio system with four woofers, there can be, as an example, as many as 28 parameters to tune for each woofer. This high number of degrees of freedom makes it impractical to manually achieve an optimal setting, as adjusting parameters to improve the frequency response at one listening position may degrade the frequency response at another listening position. Conventional automated solutions often adjust delays, gains, and use equalization filters to maximize constructive interference, however those conventional solutions have limitations in their ability to fully optimize complex audio systems with many speakers, complex listening environments and highly varying listening positions.

### SUMMARY

Accordingly, there is a need for advanced techniques for tuning multi-channel audio systems, which alleviate or mitigate at least some of the above-identified restrictions and drawbacks.

This need is met by the features of the independent claims. The features of the dependent claims define further advantageous examples.

The computer-implemented method for determining audio signal processing parameters for a multi-channel audio system including a plurality of speakers comprises the following steps.

In a step, at least a first audio response of the audio system is obtained at a first listening position of a plurality of listening positions. At least one second audio response is obtained at a second listening position of the plurality of listening positions different from the first listening position, wherein a respective channel audio signal based on an input audio signal over a predetermined frequency range was output by a respective speaker of the plurality of speakers in a listening environment of the multi-channel audio system. Additionally, the audio signal processing parameters are determined based on a similarity metric calculated between the at least one first audio response and the at least one second audio response over at least a part of the predetermined frequency range, and the audio signal processing parameters are provided for further processing of at least one of the channel audio signals.

Furthermore, the corresponding computing device is provided for determining the audio signal processing parameters as indicated above or as discussed in further detail below.

By the disclosed techniques, a balanced and consistent audio experience across the multiple listening positions can be achieved, despite the varying acoustic interactions between the speakers, listening environment, and listening positions. Thereby, optimal tuning parameter settings may be determined for an audio system based on a given configuration of a plurality of speakers and listening positions in a given listening environment.

It is to be understood that the features mentioned above and features yet to be explained below can be used not only in the respective combinations indicated, but also in other combinations or in isolation, without departing from the scope of the present disclosure. In particular, the features mentioned above and those yet to be explained below may be used not only in the respective combinations indicated, but also in other combinations or in isolation without departing from the scope of the disclosure.

Therefore, the above summary is merely intended to give a short overview over some features of some embodiments and implementations and is not to be construed as limiting. Other embodiments may comprise other features than the ones explained above.

### BRIEF DESCRIPTION OF THE DRAWINGS

These and other objects of the disclosure will be appreciated and understood by those skilled in the art from the detailed description of the preferred embodiments and the following drawings in which like reference numerals refer to like elements.

FIG. 1 schematically illustrates a system flow chart of an audio system, according to various examples.

FIG. 2 schematically illustrates an audio system with four woofers and microphone arrays positioned at four seat locations, according to various examples.

FIG. 3 schematically illustrates exemplary combined woofer responses at each of the four seat locations the of FIG. 2, according to various examples.

FIG. 4 schematically illustrates the combined woofer responses of the audio system at all 24 microphone positions of FIG. 2, according to various examples.

FIG. 5 schematically illustrates the modified combined woofer responses of FIG. 4 after channel delay optimization, according to various examples.

FIG. 6 schematically illustrates selected frequency regions for the modified combined woofer responses of FIG. 5 for application of allpass filters, according to various examples.

FIG. 7 schematically illustrates the combined woofer responses after channel delay and allpass filters optimization, according to various examples.

FIG. 8 schematically illustrates the accumulated difference metric for combined woofer responses used to select frequency regions for application of all-pass filters, according to various examples.

FIG. 9 schematically illustrates steps of a method for determining audio signal processing parameters of an audio system, according to various embodiments.

### DETAILED DESCRIPTION

In the following, embodiments of the disclosure will be described in detail with reference to the accompanying drawings. It should be understood that the following description of embodiments is not to be taken in a limiting sense. The scope of the disclosure is not intended to be limited by the embodiments described hereinafter or by the drawings, which are taken to be illustrative examples of the general inventive concept. The features of the various embodiments may be combined with each other, unless specifically noted otherwise.

Some examples of the present disclosure generally provide for a plurality of circuits, data storages, connections, or electrical devices such as e.g. processors. All references to these entities, other electrical devices, and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

The drawings are to be regarded as being schematic representations, and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Hereinafter, techniques are described that relate to similarity metric-based multi-listening position audio system optimization. This involves determining audio signal processing parameters for a multi-channel audio system including a plurality of speakers to achieve a balanced frequency response across multiple listening positions.

It is to be understood that the described techniques are described with regard to a car audio system, however it is clear that the techniques can be used for any audio system that comprises playing an audio signal for one or more users at a plurality of listening positions, or even optimizing a multi-channel audio system for a single listening position. The provided techniques may be readily applied to other kinds and application fields of multi-channel audio systems, such as for example public or private spaces or buildings.

Although the disclosed techniques have been described with respect to certain preferred embodiments, equivalents and modifications will occur to others skilled in the art upon the reading and understanding of the specification. The present disclosure includes all such equivalents and modifications and is limited only by the scope of the appended claims.

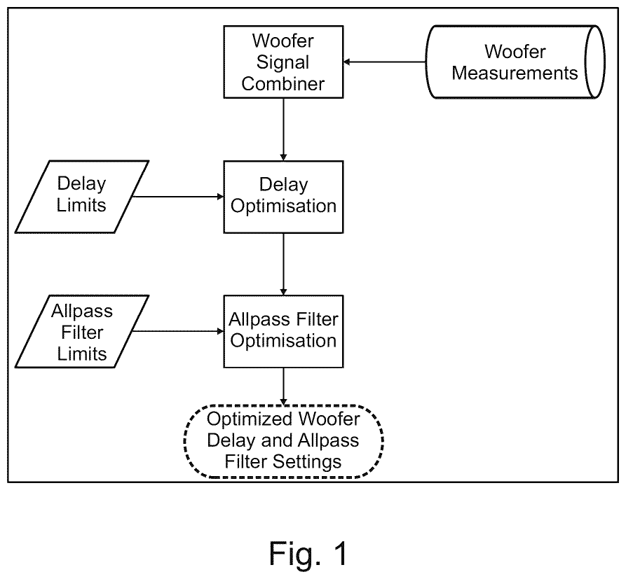

FIG. 1 schematically illustrates a system flow chart of an audio system, according to various examples.

A multi-channel car audio system is configured to generate optimized tuning parameters for achieving a balanced bass response across multiple listening positions. The tuning parameters may generally be referred to as audio signal processing parameters, used to process one or more channel audio signals of the audio system.

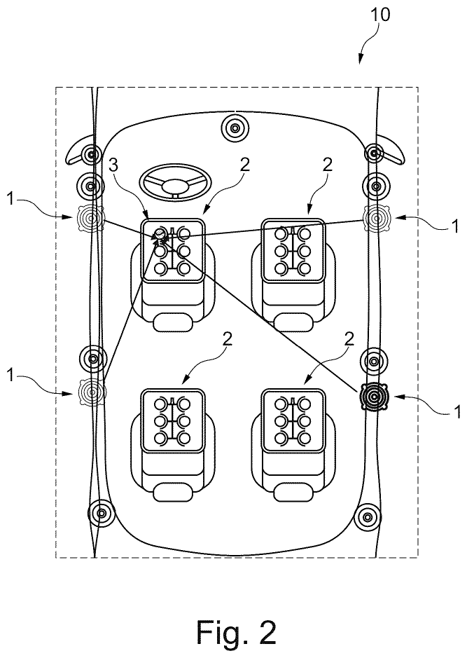

The audio system optimizes the audio signal processing parameters based on a cross-correlation-based loss function, in order to ensure a consistent bass response across all seats in a car, based on individual audio response measurements of each woofer. The spatial configuration of the car audio system will be explained in further detail with regard to FIG. 2.

In low frequency ranges, as described in the following examples, the disclosed techniques may be particularly advantageous, however, it will be understood that the disclosed techniques can also be applied in other frequency ranges. Accordingly, the woofers, or woofer speakers, can generally be referred to as speakers of the audio system. A bass response or woofer response of the audio system can generally be referred to as audio response of the audio system.

An input test audio signal is processed to generate individual channel test audio signals that are each associated with a respective speaker. These channel audio signals are output separately and individually by the speakers, and the resulting sound fields in the listening environment are measured using microphones at various listening positions. The woofer responses, specifically impulse responses of each woofer, are measured individually at each microphone position (i.e. listening position). Each woofer is measured in isolation of the other woofers, using a test audio signal.

As can be seen in FIG. 1, the multiple individual woofer measurements, each based on a unique combination of single woofer and microphone, are provided in the system workflow as input data.

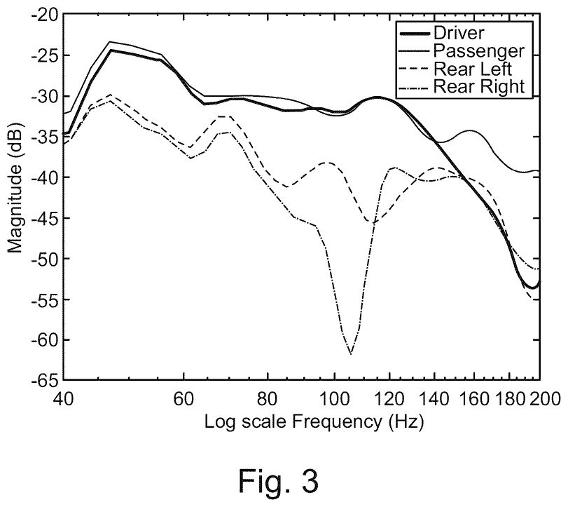

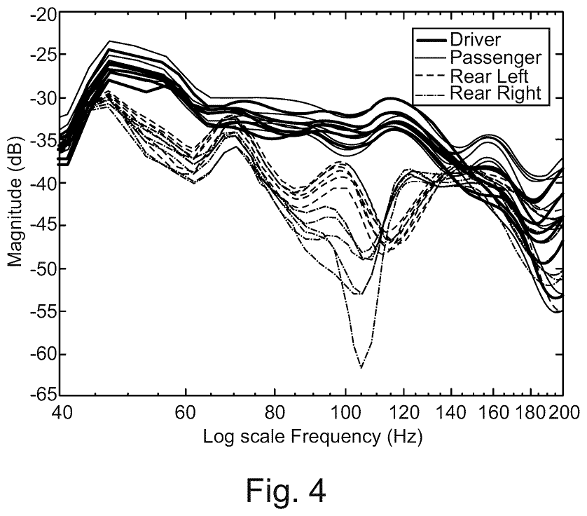

These individual measurements are then combined using a woofer signal combiner to generate a set of combined woofer responses, wherein each combined woofer response corresponds to a different listening position and includes the various individual woofer measurements at the respective listening position, as illustrated in further detail in FIGS. 3 and 4. Therefore, the combined frequency response at each listening position can generally be referred to as combined audio response and represents the overall sound from all woofers at the respective listening position.

Each of these combined frequency responses is provided as input data to the optimization process, which optimizes the signal processing parameters, in order to achieve a similar spectral shape across all combined woofer responses.

The optimization process is performed in two steps to determine the audio signal processing parameters, including channel delays and phase filter parameters, to maximize the similarity of the combined impulse responses across all the listening positions.

In a first optimization step, the delay optimization, the combined woofer responses are processed in a channel delay optimization process. The delay optimization process maximizes the cross-correlation of the combined woofer responses across all listening positions, by shifting the channel audio signals relatively to each other by time delays.

The channel delay optimization process takes into account specific delay limits or boundaries, that may be provided as additional input data, and determines optimized channel delay settings that maximize the similarity or correlation between the combined woofer responses across the different listening positions.

For at least one channel audio signals a time delay to applied to the channel signal is determined, that better aligns the woofer responses with each other. The channel time delays across the multiple audio channels are optimized using a correlation-coefficient-based error function. This aligns the combined woofer responses in time to be as similar as possible based on a time shift of channel audio signals. Modified combined woofer responses are provided based on the optimized channel delays.

In a following optimization process, the all-pass filter optimization, the modified woofer responses with corrections by the optimized channel delays are further processed to determine all pass filter settings regarding a set of all pass filters to be applied to the modified woofer responses. The allpass filter optimization process takes into account allpass filter limits or boundaries, that may be provided as additional input data.

In particular, frequency regions that require further phase alignment are identified based on first-order derivative differences between the combined woofer responses. Allpass filters are optimized, again using the correlation-coefficient error function, and are placed at these regions for each speaker channel to further increase the similarity of the modified combined responses.

The goal of this second optimization process is to find optimal allpass filter settings that further enhance the similarity or correlation between the combined woofer responses. During this phase/allpass filter optimization process, the most appropriate frequencies or frequency bands are identified for placing a phase filter and the corresponding filter parameters are adaptively determined to maximize the cross-correlation of the modified combined woofer response across all listening positions.

The output of these two optimization processes is a set of optimized woofer delay and allpass filter parameter settings. These parameter settings are optimized to achieve a similar bass (frequency) response across all the listening positions based on the provided woofer measurements and the specified delay and allpass filter limits, which allows users to specify the allowable ranges for delay and filter parameters.

As an optional step, global EQ filters can be applied to system input audio signal to shape the overall response to a desired target shape, wherein the balanced bass responses achieved through the optimization processes remains unaffected.

Once the optimization processes are complete, the system provides the optimized audio signal processing parameters for implementation. These optimized signal processing parameters can be, for example stored in the audio system and used when playing back further audio materials. The optimized channel delay and allpass filter parameters can then be applied to a further input audio signal to generate the channel signals that drive the speakers. This results in a more balanced sound field with a consistent bass response across all the listening positions.

By automatically generating optimized tuning parameters, this system improves the process of achieving a balanced bass response across multiple listening positions in a car. The use of a cross-correlation loss function enables the system to find efficiently a combination of optimized delay and phase filter settings.

FIG. 2 schematically illustrates an audio system 10 with four woofers 1 and microphone arrays 2 positioned at four seat locations, according to various examples.

As can be seen in FIG. 2, the car audio system 10 comprises four woofer speakers 1, or short woofers, and four microphone arrays 2 positioned at four seat locations in a car. While further speakers are depicted in the audio system, the following explanation will focus on the four woofers 1, for demonstration purpose. It will be understood that the described technique can similarly be applied to any number of further speakers.

The car has four seat locations, corresponding to four occupant seats of the vehicle. At each seat location, an array 2 of six microphones, also referred to as microphone capsules, is placed to acquire sound field measurements at different occupant heights or head orientations. These microphone arrays 2 are used to acquire measurements at the four primary seating positions, with each array containing multiple microphone capsules to capture variations in listener head position and orientation. A microphone 3 position may, in this regard, be referred to as listening position of the car audio system. Each microphone position corresponds to a different listening position in the listening environment.

In FIG. 2, the contributions to the sound fields of each of the four woofers 1 are exemplarily depicted as arrows pointing towards a first microphone 3 at a first listening position. This illustrates how the woofer and microphone setup in the car is used for measurements of the sound field at a respective listening position of the first microphone 3 based on sound fields from all four woofers. The measurements of each woofer for by each microphone in a microphone array are summed to arrive at a combined woofer or bass response on a per-mic-capsule basis for each listening position. This process of combining the four woofer measurements is repeated for all 24 microphone capsules.

During the measurement process, each woofer is driven individually based on a (system) test audio signal. The microphones at each listening position capture the resulting impulse response simultaneously. This process is repeated for each speaker, resulting in a set of individual channel measurements, which can generally be referred to as channel audio responses, at each microphone capsule position across all seat positions. For each microphone, the plurality of channel measurements is then combined to form a combined woofer response for the respective microphone position, as illustrated in FIGS. 3 and 4.

FIG. 3 schematically illustrates exemplary combined woofer responses at each of the four seat locations the of FIG. 2, according to various examples.

The four different woofer responses are represented as frequency responses by the four lines in FIG. 3 and illustrate the challenge of achieving a balanced bass response across the multiple seat locations in the car audio system. For each seat location an exemplary microphone of the microphone array is depicted.

Each line in FIG. 3 represents a combined woofer response at a different seat location of the car audio system depicted in FIG. 2. The woofer responses are depicted as magnitude responses in the frequency domain at specific listening positions over a predetermined frequency range of 40 Hz to 200 Hz. Each line represents a summation of the frequency responses based on the individual audio channel measurements at the respective seat location.

In detail, as can be seen in FIG. 3, the four plotted lines represent the combined woofer frequency response at each of the four seat locations: Driver, Passenger, Rear Left, and Rear Right. Each curve represents the combined frequency response of all woofers measured at one representative microphone capsule per seat location.

FIG. 3 illustrates, how the bass response across a 4-seat car can vary between different seat locations. These exemplary four microphone positions and woofers are chosen to demonstrate the large differences in the spectral shape of the woofer responses that can occur in a car audio system. It will be understood that similar considerations apply to other combinations of speakers and listening positions, for example different head heights, and the other speakers in the audio system.

As can be seen in FIG. 3, the frequency responses specifically between the rear right seat location and the front seat locations are noticeably different.

This multivariate problem of using a plurality of available tuning parameters to achieve a balanced bass response across all seats in a car typically involves too many degrees of freedom for a human to manage effectively. At a minimum, in this example with 4 woofer speakers, there may be 4 channel delay parameters and 2 phase filters with 3 parameters each, which equates to a total of 28 parameters to be tuned. Furthermore, an improvement at one seat location might result in a degradation at another seat location. Therefore, conventionally, often approximations and tradeoffs are accepted to achieve a satisfactory bass response at each of the listening positions within a reasonable time frame. Conventionally, sound field management systems adjust channel delay values to maximize constructive interference. However, this can conflict with achieving a similar frequency response across all seat locations, as the summation of all the woofers will produce different responses at different seats.

The aim of the techniques according to the present disclosure is to provide an automated approach for achieving a balanced bass response across all listening positions, meaning that the spectral shape of the audio response, for example, should be the same, or at least as similar as possible, in the front seat locations as compared to the rear seat locations.

To address this challenge, the use of correlation coefficients as similarity measure in a loss function for a gradient-based optimization of delay and biquad, specifically allpass, filter parameters is described in further detail in the following.

The disclosed techniques comprise optimizing the spectral shape of at least one audio response during an optimization process by providing optimized filter parameters for filtering the channel audio signals. By aiming to make the frequency responses at all seats sufficiently similar, EQ filters can then be applied to the input source audio to achieve the desired final target curve shape. Furthermore, a method for determining allpass filter placement based on the accumulation of first-order derivative differences across a set of frequency responses, followed by a peak-picking algorithm, will be described.

FIG. 4 schematically illustrates the combined woofer responses of the audio system at all 24 microphone positions of FIG. 2, according to various examples.

FIG. 4 provides a more detailed view of the 24 combined woofer responses, each of which are a combination of four individual measurements based on the four woofers separately by one of the 24 microphones. At each seat location, a microphone array with 6 microphones is located. Each microphone (microphone position), therefore, corresponds to a different listening position and is used to provide input data for the optimization process.

The displayed 24 combined woofer responses include the 4 woofer responses depicted in FIG. 3 and are provided to the following optimization process as input data.

At each seat location (driver, passenger, rear left, rear right) a group of 6 microphone capsules, or short microphones, acquire measurements of the sound field at different positions and orientations, simulating variations in listener head position and orientation. The resulting group of 6 woofer response curves for each seat are visibly different from each other, indicating that the sound impression can vary noticeably even within a single seat location.

As can be seen from FIG. 4, the woofer responses from the microphone arrays at the front seats of the car are generally more similar to each other, as compared to the woofer responses from the microphone arrays at the rear seats of the vehicle. The woofer responses are represented in the frequency domain, where a magnitude in dB of each signal is depicted over the frequency in Hz.

The measured microphone signals may be considered the measured audio responses at the different listening positions. The depicted representations of the measured audio responses comprise a line representing a signal envelope of the magnitude of the respective frequency responses. The variations in the audio responses in magnitude over the frequency, and accordingly the shape of the frequency response curves, demonstrate the different bass responses across all listening positions. These differences in the combined woofer response at each microphone capsule position result in a noticeably different sound impression for listeners at each seat.

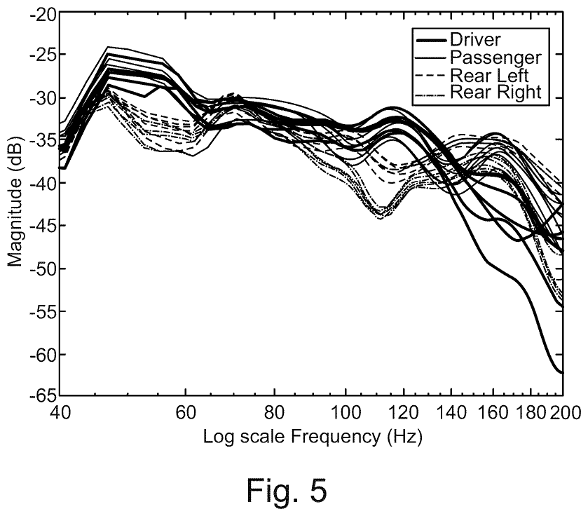

FIG. 5 schematically illustrates the modified combined woofer responses of FIG. 4 after channel delay optimization, according to various examples.

FIG. 5 shows the 24 combined woofer responses, after application of optimized channel delays, Accordingly, as can be seen, particularly from the woofer responses at the rear seats, the depicted modified combined channel audio responses are already more similar than before the channel delay optimization.

As described herein, in the first optimization step, also referred to as channel delay optimization, using a correlation-coefficient-based error function with a gradient-based non-linear multivariable optimizer, channel time delays for one or more of the four woofer channel audio signals are simultaneously optimized to increase the correlation coefficient across all the combined woofer responses.

In this first optimization step, the combined woofer responses are processed to maximize the cross-correlation of the combined woofer responses across all listening positions by shifting the channel audio signals relative to each other by time delays, and calculating the resulting combined woofer responses using the initially separately measured individual channel audio responses.

By the channel delay optimization, the error function is used to assess the similarity of the individual 24 signals of the combined woofer responses. During the optimization process, an optimized set of channel delay parameters is found, and the combined woofer responses at each listening position are re-generated (simulated) for all 24 microphone capsules based on the optimized channel delay parameters.

In each iteration, the correlation coefficient for a set of unique pairs of combined woofer responses, represented by the microphone capsule signals, is calculated and accumulated to an accumulated similarity metric. For example, unique pairs may have the meaning that the correlation between microphone capsule number 1 and 14 is calculated but the number 14 and 1 case is not calculated as it is the same combination.

The optimization process aims to increase the total accumulated similarity metric. This means the spectral shape of the combined frequency responses will become more similar with every iteration of the channel delay optimization.

The channel delay optimization process takes into account specific delay limits or boundaries that may be provided as additional input data. It determines optimized channel delay settings that maximize the similarity or correlation between the combined woofer responses across different listening positions.

FIG. 5 displays the resulting modified combined woofer responses after the channel delays have been optimized and applied. While not perfect, the combined responses are much more similar than before the delay optimization, as seen in FIG. 4. To further improve the similarity, phase filters can be used at specific frequencies, as will be explained in the following.

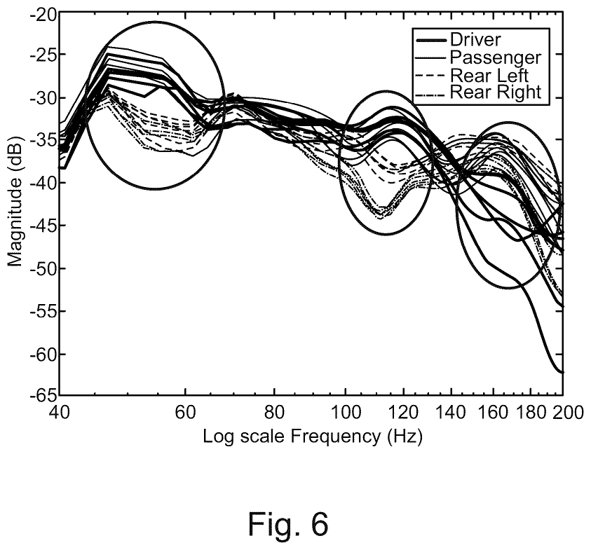

FIG. 6 schematically illustrates selected frequency regions for the modified combined woofer responses of FIG. 5 for application of allpass filters, according to various examples.

FIG. 6 shows the selected frequency regions where the allpass filters are to be applied based on the analysis of the frequency response differences after the channel delay optimization. These regions are chosen to further improve remaining problem areas and further enhance the similarity of the frequency responses across the listening positions.

As can be seen in FIG. 6, based on the results of the channel delay optimization of FIG. 5, specific frequency regions or frequency bands can be selected, that require further optimization. In these selected frequency regions, allpass filters will be placed for further improvement.

The markings in FIG. 6 highlight the remaining problem areas where the frequency response shapes differ. To determine these frequency regions where adjustments need to be made using optimized allpass filters, an allpass filter placement algorithm (peak picking algorithm) is employed. The algorithm aims to select frequency regions where the woofer response shapes are most different, as indicated by peaks in a difference metric. These regions require further optimization to achieve a more balanced sound experience across all listening positions.

The peak-picking algorithm uses a first-order derivative-based equation to generate a metric that increases in value where the frequency response shapes exhibit significant differences. The equation takes into account the first derivative of the frequency responses and calculates a value that is maximized at the frequencies where the differences between the response shapes are highest.

The equations used for this purpose are as follows:

$$U ( s ) = {\sum }_{l = 0}^{L} {\sum }_{ω = ω LL}^{ω UL} \{ \begin{matrix}{F}^{′} ( ω , l ) , & {F}^{′} ( ω , l ) \geq 0 \\ 0 , & otherwise\end{matrix}$$

$$D ( s ) = {\sum }_{l = 0}^{L} {\sum }_{ω = ω LL}^{ω UL} \{ \begin{matrix}{F}^{′} ( ω , l ) , & {F}^{′} ( ω , l ) < 0 \\ 0 , & otherwise\end{matrix}$$

$$P = {\sum }_{l = 0}^{L} U ( l ) \cdot {\sum }_{l = 0}^{L} \vert D ( l ) \vert$$

In these equations, F′ represents the first derivative of a woofer frequency response, ω is the discrete frequency index between the lower limit (ωLL) and the upper limit (ωUL), which are based on the frequency limits of the speakers. The variable I represents the signal index up to the total number of signals (L), which in this case is 4 seats×6 microphone carrier arrays, resulting in 24 signals.

By applying these equations to the set of frequency responses, a 1-D vector is obtained, which is maximized at the frequencies where the differences between the frequency response shapes are most significant. These frequencies serve as the initial conditions for the placement of the allpass filters.

In particular, the first two equations, U(s) and D(s), are used to calculate the sum of the positive and negative values of the first derivative of the frequency responses, respectively.

Therein, F′(ω, I) represents the first derivative of the frequency response at frequency ω and signal index I. The equations iterate over the frequency range from ωLL (lower limit) to ωUL (upper limit) and over the signal indices from 0 to L (total number of signals). For U(s), if the first derivative F′(ω, I) is greater than or equal to zero, its value is added to the sum; otherwise, zero is added. For D(s), if the first derivative F′(ω, I) is less than zero, its value is added to the sum; otherwise, zero is added.

The third equation, P, combines the results of U(s) and D(s) to calculate the accumulated difference metric. The equation iterates over the signal indices from 0 to L. For each signal index I, it multiplies the value of U(I) (sum of positive derivatives for signal I) with the absolute value of D(I) (sum of negative derivatives for signal I). The products are then summed up to obtain the final value of P.

The purpose of these equations is to generate an accumulated difference metric that quantifies the differences between the frequency response shapes across the listening positions. The metric P is maximized at the frequencies where the differences between the response shapes are most significant.

The first derivative F′(ω, I) captures the rate of change of the frequency response at each frequency and signal index. By summing up the positive and negative values of the derivatives separately in U(s) and D(s), the equations identify the frequencies where the responses are moving in opposite directions. The multiplication of U(I) and |D(I)| in the final equation P amplifies the metric value when both positive and negative derivatives have significant magnitudes, indicating a strong difference between the response shapes.

By applying this difference metric to the frequency responses, a 1-D vector is obtained, which is maximized at the frequencies where the differences between the response shapes are most pronounced. These frequencies serve as the initial conditions for the placement of the allpass filters during the optimization process.

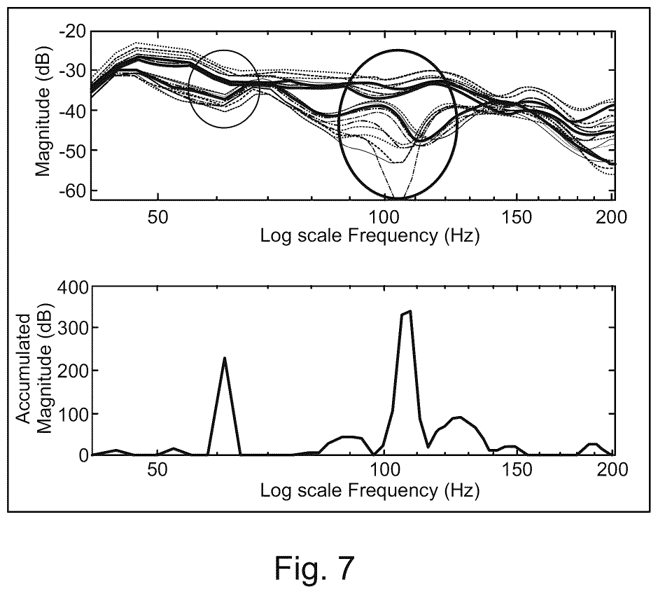

FIG. 7 schematically illustrates an accumulated difference metric for combined woofer responses used to select frequency regions for application of allpass filters, according to various examples.

In the lower part of FIG. 7, the resulting 1-D vector of an accumulated difference metric is depicted.

As can be seen in FIG. 7, the difference metric displays peaks in frequency regions with increased differences between the line representations of the adapted combined woofer responses.

A peak-picking algorithm is then applied to the resulting 1-D vector to determine the specific frequencies along the frequency axis where the allpass filters should be initially placed. The center frequency parameter of each allpass filter is optimized along with the other phase filter parameters during the allpass filter optimization process.

This accumulated difference metric provides a computationally efficient approach to identify the frequency regions that require further optimization using allpass filters to achieve a more balanced sound experience across all listening positions.

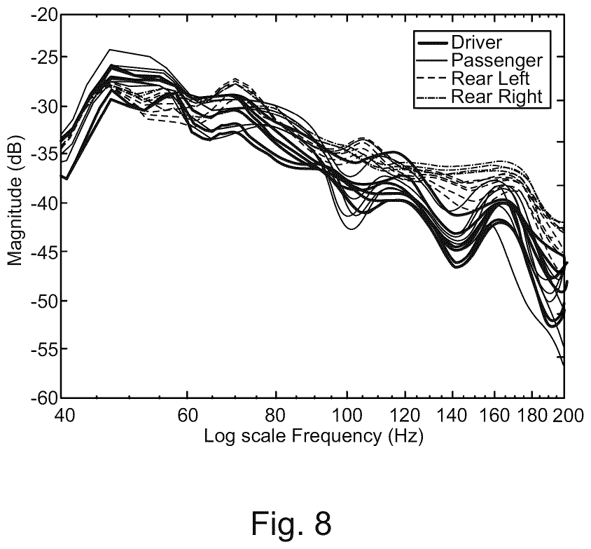

FIG. 8 schematically illustrates the combined woofer responses after channel delay and allpass filters optimization, according to various examples.

Displayed in FIG. 8 are the woofer responses after both the channel delay optimization and the allpass filter optimization have been applied to the audio system. The figure demonstrates the improvement in the similarity of the frequency responses across the listening positions compared to the results obtained after the delay optimization alone, as shown in FIG. 5.

The allpass filter optimization process follows the channel delay optimization and aims to fine-tune the allpass filter parameters to further enhance the consistency of the sound experience across all listening positions. The optimization process takes into account the initial allpass filter placements determined based on the frequency regions identified in FIG. 6 and uses the optimized channel delays of the first channel delay optimization process.

During the optimization process, the parameters of the allpass filters, such as the center frequency, quality factor, and phase shift, are adjusted to minimize the differences between the frequency response shapes. The goal is to achieve a higher degree of similarity among the responses, resulting in a more balanced sound field for all occupants in the car.

The optimized allpass filters effectively address the remaining problem areas that were present after the delay optimization. By carefully manipulating the phase response of specific frequency regions, the allpass filters help to align the frequency responses and create a more cohesive sound image across the listening positions.

FIG. 8 shows the improvement in the similarity of the speaker frequency responses after the application of both the optimized channel delays and allpass filters. The frequency responses exhibit a higher level of consistency and alignment compared to the responses obtained after delay optimization alone.

The combined optimization process, involving channel delay adjustment and allpass filter optimization, successfully minimizes the variations in the frequency responses across the listening positions. This results in a more balanced audio experience for all occupants in the car, ensuring that each listener perceives a similar sound quality regardless of their seating position.

By using the correlation-coefficient-based error function in a gradient-based optimization technique, the audio system provides a significant enhancement in the overall sound reproduction for all listening positions.

The disclosed automated sound field management techniques offer several advantages over manual tuning processes and conventional automated methods for achieving a balanced bass response across multiple listening positions. The system can arrive at optimized tuning results significantly faster compared to manual tuning and conventional automated techniques. The disclosed techniques allow the audio system to computationally find optimal solutions even in complex spatial audio configurations. The use of biquad allpass filters for phase corrections offers a more computationally efficient alternative to conventional FIR filters. Biquad filters require fewer coefficients and less processing power, making them a cost-effective choice for real-time audio processing applications. By using similarity measures of tonal representations instead of time-of-arrival or interference maximization, the techniques can optimize the overall listening experience across all seats in the car without significantly impacting the spatial perception.

The automated sound field management system provides a fast, efficient, and precise solution for achieving a balanced bass response in complex multi-channel, multi-position audio systems. Its ability to handle increased complexity and computationally efficiently determine signal processing parameters based on initial measurement data on separate audio channels provides significant improvement over manual tuning and conventional automated methods.

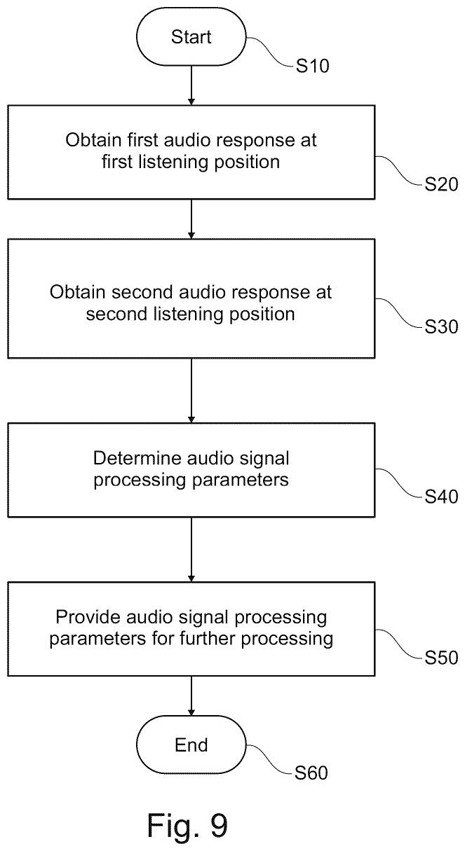

FIG. 9 schematically illustrates steps of a method for determining audio signal processing parameters of an audio system, according to various embodiments.

The method starts in step S10. In step S20, at least one first audio response is obtained at a first listening position of a plurality of listening positions. In step S30, at least one second audio response is obtained at a second listening position of the plurality of listening positions different from the first listening position, wherein a respective channel audio signal based on an input audio signal over a predetermined frequency range was output by a respective speaker of the plurality of speakers in a listening environment of the multi-channel audio system. In step S40, the audio signal processing parameters are determined based on a similarity metric calculated between the at least one first audio response and the at least one second audio response over at least a part of the predetermined frequency range. In step S50, the audio signal processing parameters are provided for further processing of at least one of the channel audio signals. The method ends in step S60.

From the above said, the following general conclusions can be drawn:

In general, an audio response, in the context of a multi-channel audio system, may represent measured sound field characteristics resulting from the playback of an input audio signal through the system's loudspeakers in a specific listening environment. An input audio signal is processed and split into individual channel audio signals. These channel audio signals are then broadcast by the corresponding loudspeakers, each outputting a specific sound field component.

As the sound fields from the loudspeakers propagate through the listening environment, they interact with the room's acoustic characteristics, such as reflections, absorption, and diffraction. These interactions can introduce various audio effects, including reverberation, echoes, and spectral coloration, which contribute to the overall perception of the sound at different listening positions within the room. Moreover, the sound fields from different loudspeakers may interfere with each other constructively or destructively, depending on factors such as their relative positions, phase relationships, and the frequency content of the audio signals. These interferences can also result in spatial variations of the sound field, affecting the tonal balance, clarity, and localization of the audio at different listening positions.

To assess the audio response at a specific listening position, measurements are typically conducted using microphones or microphone arrays placed at that position. These measurements acquire the combined effect of the loudspeaker output, room acoustics, and interferences, providing a representation of the actual sound field experienced by a listener at that location. The measured audio response can be analyzed and characterized as various different representations, such as the time domain (e.g., impulse response), frequency domain (e.g., magnitude and phase response), or spatial domain (e.g., directional information), as described herein.

By comparing the audio responses, the similarity or dissimilarity of the sound field characteristics across the listening positions can be quantified. This information can for example be used in a loss function for optimizing the audio signal processing parameters, such as delays, equalization, or spatial processing, to achieve a more consistent audio experience for all listening positions.

In various examples, the similarity metric may represent a similarity between the audio responses, particularly between representations (of the same representation type) of the respective audio responses. Accordingly, it is possible to quantify the similarity between the audio responses at different listening positions based on, or using, their respective representations.

In various examples, the first and second audio response each may comprise a combination of separate individual channel audio responses (each speaker separately measured at the respective listening position) for each of the first and second listening position. The first audio response may comprise a combined audio response at the first listening position, wherein different speakers are separately measured at the first listening position and combined. The second audio response may comprise a combined audio response at the second listening position, wherein different speakers are separately measured at the second listening position and combined. Such combined audio responses at each of the listening positions can, for example, advantageously be used for determining channel delay parameters, or phase filter parameters.

In various examples, the first and second optimization steps may be applied simultaneously in a combined optimization process. The channel delay parameters and phase filter parameters may be jointly optimized to achieve the best overall similarity between the audio responses across listening positions.

In various examples, the input audio signal may be received with the intent of being reproduced similarly at each listening position. The input signal may be processed to generate the channel signals for each speaker, using the optimized audio signal processing parameters.

The similarity metric may be defined between vectorized representations of the audio responses or portions thereof. For example, the vectors may represent the magnitude response, phase response, or impulse response over the analyzed frequency range.

A channel delay may be referred to as inter-channel phase difference.

In various examples, the similarity metric may represent a statistical similarity measure or signal similarity measure between the first audio response and the second audio response over at least a part of the predetermined frequency range. The similarity metric may be a numerical value calculated based on a mathematical operation applied to the first audio response and the second audio response, where the mathematical operation quantifies a relationship between the two responses. Some examples of suitable mathematical operations include cross-correlation, mean squared error (MSE), normalized root mean squared error (NRMSE), or other distance measurements. The cross-correlation operation may be particularly suitable as it can represent both the magnitude and phase relationships between the audio responses. The resulting cross-correlation coefficient may range from −1 to +1, where +1 indicates a perfect positive correlation, −1 indicates a perfect negative correlation, and 0 indicates no correlation. Other similarity measures may provide alternative ways to compare the audio responses, such as by treating them as high-dimensional vectors in the case of cosine similarity, or by allowing for non-linear time-shifting in the case of DTW distance.

The optimization process may be a gradient-based optimization process that iteratively adjusts the audio signal processing parameters to maximize the similarity metric or minimize a loss function based on the similarity metric between simulated combined audio responses at the listening positions. The optimization may use techniques such as stochastic gradient descent (SGD), where the parameters are updated based on a subset of the data at each iteration, or variants such as Adam (adaptive moment estimation) that adapt the learning rate for each parameter. The loss function may be defined as the negative of the similarity metric, such that minimizing the loss function corresponds to maximizing the similarity between the audio responses.

A computer-implemented method is provided for determining, in other words optimizing, tuning parameters of an audio system. Tuning parameters can also be referred to as audio signal processing parameters of an audio system. The audio system can be configured as a multi-channel audio system, comprising a plurality of speakers, also referred to as loudspeakers, which are spatially distributed in different positions within an acoustic listening environment, and which output or broadcast at least part of a sound field in the listening environment for one or more listeners. Audio signal processing parameters may be used to process one or more audio signal in the audio system before broadcasting the sound field. Determining audio signal processing parameters can be referred to as determining adjusted, or adjusting, audio signal processing parameters.

The audio system may, for example, comprise a vehicle or car audio system. The audio system can include a computing device and/or or control unit configured to carry out any method or any combination of methods according to the present disclosure.

The audio system may be referred to as a multi-channel audio system, which may be an audio system that has multiple independent audio channels, where each channel carries a separate channel audio signal determined based on a (system) input audio signal. Common examples can be stereo (2-channel), 5.1 surround sound (6-channel), and 7.1 surround sound (8-channel) systems, or any other number or combination of channels or speakers. Each channel may be typically played back through one or more dedicated speakers arranged at fixed positions in the listening environment, wherein a sound field is generated by the speakers in the listening environment. Due to the fixed correspondence of an audio channel to at least one corresponding speaker, or subset of speakers, measurements based on a speaker may be regarded equivalent to measurements of the corresponding channel audio signal, and vice versa.

The input audio signal may refer to an original audio content that is to be played back by the multi-channel audio system. This could, for example, be music, movie soundtrack, video game audio, or similar content to be played for the one or more listeners. The input audio signal may be processed to generate a plurality of channel audio signals, which may be referred to as separate channel audio signals derived from the input audio signal, one for each channel of the multi-channel system. In other words, the input audio signal is processed and split into the individual channel audio signals, which are then provided to and output by the corresponding individual speakers. The processing may include applying a respective different subset of audio signal processing parameters to each respective channel audio signal.

The audio system may be further be referred to as a multi-listening position audio system, i.e. as audio system with multiple listening positions, wherein a plurality of listeners, situated at different locations and/or in different listening poses/orientations are arranged within the acoustic environment, are subjected to sound fields generated by the plurality of speakers. Generally, two or more, or all, speakers may simultaneously output respective sound fields to each of the listening positions while playing back the audio content.

A listening environment may refer to the physical space where the multi-channel audio system is set up and in which the audio will be heard by the listeners. Speakers and/or listening positions may be located within the listening environment. This could be, for example, a room in a home, a movie theater, a vehicle or car interior, etc. The characteristics of the listening environment (size, shape, materials, etc.) can significantly impact the perceived sound at each of the listening positions.

Listening positions in the listening environment may correspond to specific locations within the listening environment where listeners, in particular the ears of the listeners would typically be situated. Therefore, the different listening positions may comprise different locations of a listener, and may further also comprise different listening poses of the listener. These combinations of listener locations and listening poses may, for example, be regarded as coordinates in a listening space. For example, in a home theater setup, the listening positions could be the different seating locations on the couches. In a car audio system, the listening positions would be the different seating positions (driver, front passenger, rear seats). Listening poses may refer to different listener geometries (e.g. listener head heights), and/or different orientations of a listener. In various example, a listening position may refer to a unique combination of the above. The audio experience can vary between different listening positions, or for different points in the listener space, due to factors like the relative positions and distances to the speakers and sound-shaping geometries in the listening environment.

In various examples, each individual speaker in the multi-channel system receives and plays back a specific channel audio signal, in other words each channel audio signal is played back by at least a respective one or a respective subset of speakers. For example, in a 5.1 system, the center channel speaker may receive and play back the center channel audio signal, the front left speaker may play the front left channel audio signal, and so on. The sound from all the speakers combines in the listening environment to create the sound field for the overall audio experience of the listeners.

A listening position may be representatively measured, using a test audio signal as input audio signal, by a microphone positioned and oriented in a corresponding representative manner, as will be described in the following.

The at least one first audio response corresponds to, or is associated with, a first listening position of a plurality of listening positions in the listening environment of the audio system. The first audio response was measured at the first listening position.

In various examples, for each audio channel, the corresponding channel audio signal may be broadcasted separately into the listening environment, and a corresponding channel audio response may be measured at the first listening position based on a separate channel audio signal only.

For example, a first channel audio response may be measured at the first listening position, while only a first channel audio signal of the plurality of channel audio signals was output, for example by a at least one first speaker of the plurality of speakers in the listening environment of the multi-channel audio system. The first channel audio signal is determined based on the input audio signal over a predetermined frequency range. Similarly, a second channel audio response, and a third, or fourth, etc. may be measured at the first listening position.

In various examples, the first audio response may be a combination of individually measured channel audio responses measured at the first listening position. In general, it would also be possible, that the first audio response corresponds to a single measurement at the listening position. It would also be possible that the first audio response was measured, while two or more audio channel signals were broadcasted by at least two speakers simultaneously. Therefore, the first audio response of the audio system may be generally based on the input audio signal (e.g. based on two or more channel audio signals and/or two or more respective speakers) and may be measured at a first listening position.

In a further step, at least a second audio response is obtained. The at least one second audio response corresponds to, or is associated with, a second listening position of the plurality of listening positions. The second audio response was measured at the second listening position.

In various examples, the second audio response may be a combination of individually measured channel audio responses measured at the second listening position. For each audio channel, the corresponding channel audio signal may be broadcasted separately into the listening environment, and a corresponding channel audio response may be measured at the second listening position based on a separate channel audio signal only.

For example, a first channel audio response may be measured at the second listening position, while only a first channel audio signal of the plurality of channel audio signals was output, for example by a at least one first speaker of the plurality of speakers in the listening environment of the multi-channel audio system. The first channel audio signal may be the same as for the measurement at the first listening position. Similarly, a second channel audio response, and a third, or fourth, etc. may be measured at the second listening position.

In general, it would also be possible that the at least one second audio response was measured, while two or more audio channel signals were broadcasted by at least two speakers simultaneously. Accordingly, a second audio response of the audio system based on the input audio signal (e.g. based on two or more channel audio signals and/or two or more respective speakers) may be generally determined, for example at a second listening position.

Each audio response was acquired or measured, while at least one respective channel audio signal based on an input audio signal over a predetermined frequency range was output by at least one respective speaker of the plurality of speakers in a listening environment of the multi-channel audio system.

The audio responses may correspond to measurements of sound fields generated based on the channel audio signal output by the corresponding one or more speakers.

Determining the audio signal processing parameters may be further performed using the first and second channel audio signals at each of the first and second listening positions. Determining the audio signal processing parameters may be further performed using one, or more, or each, of the channel audio signals. The channel audio signals may be processed using the signal processing parameters, in order to determine or simulate combined audio responses at each of the listening positions.

The second listening position of the plurality of listening positions is different from the first listening position.

The input audio signal, and/or a channel audio signal, and/or a measured audio response may extend over the predetermined frequency range.

In various example, obtaining an audio response may comprise, for example, receiving measurement data from an audio sensor such as a microphone, or receiving the audio responses from memory or a permanent data storage. In various example, obtaining an combined audio response may refer to simulating or calculating an audio response.

In preferred examples, only one channel audio signal is output at a time and corresponding channel audio responses may be measured simultaneously at a plurality of listening positions, for example at the first and second listening positions.

Obtaining at least a first audio response and at least a second audio response, corresponding to a first listening position respectively second listening position, may be performed by measuring each speaker or channel audio signal separately, for example using the same test audio signal as input audio signal.

Obtaining the at least one first and the at least one second audio response may be performed using individual speaker measurements. A respective first channel audio response may be obtained at each of the first and second listening positions, based on a first channel audio signal output by at least a first speaker of the plurality of speakers. Separately from the first channel audio responses, a respective second channel audio response may be obtained at each of the first and second listening positions, based on a second channel audio signal output by at least a second speaker of the plurality of speakers.

The first channel audio response at the first listening position may be combined with the second channel audio response at the first listening position, in order to generate the first audio response at the first listening position. Similarly, the first channel audio response at the second listening position may be combined with the second channel audio response at the second listening position, in order to generate the second audio response at the second listening position.

Each of the first respectively second audio responses (as well as further audio responses at further listening positions) may therefore be referred to as a combined audio response, as it combines measurements or audio responses based on different audio channels, optionally audio responses based on all separate audio channels.

In other words, for each listening position, the audio responses from each individual speaker and/or audio channel may be measured separately and then combined to form the overall or combined audio response at that listening position.

This may allow for a detailed analysis or simulation of how each speaker contributes to the sound field at each listening position within the listening environment. It may allow to differentiate between audio channels, due to factors such as speaker placement, room acoustics, or variations of the listener geometries themselves. By measuring each channel separately, adaptions to the individual channel audio signals may be simulated during the optimization process. Distinct audio signal processing parameters, such as delays or filters, may be applied to each speaker channel independently, allowing for finer control over the audio response at each listening position. Measuring each speaker's response individually may simplify the modeling and analysis of the audio system. Each speaker may be treated as a separate entity, and its contribution to the sound field may be modeled independently.

However, it is to be understood that the techniques according to the present disclosure are not limited to audio responses measured based on a single channel audio signal, wherein, it would also be possible to optimize the signal processing parameters using measurements based on at least one combined measurements of two or more audio channels.

In a further step, the audio signal processing parameters, in general at least one audio signal processing parameter, are determined, in other words adjusted or optimized, based on or using the at least one first audio response and the at least one second audio response. The audio signal processing parameters may be used to process or modify the channel audio signals, in general at least one channel audio signal. The audio signal processing parameters may be used to adapt the channel audio signals in such a way that the audio responses at the respective listening positions become similar to each other.

In general, embodiments of the disclosure are based on the finding that the spectral shapes of the first and second audio responses may be assessed and or compared, and accordingly adapted, so that a similarity between them may be maximized. A similarity of the audio responses determined based on the same test audio signal may indicate a similar or same audio experience of the listeners.

Determining the signal processing parameters may be performed based on or using a similarity metric between the at least one first audio response and the at least one second audio response. In other words, a similarity metric may be calculated or computed based on, or using, the at least one first audio response and the at least one second audio response. The similarity metric may comprise one or more (numerical) values representing a similarity between the at least one first audio response and the at least one second audio response. The similarity metric may be calculated between the at least one first audio response and the at least one second audio response over at least a part of the predetermined frequency range.

In various examples, the determining of the signal processing parameters may be performed based on the similarity measure as criterion or measure for the first and second audio responses. In various examples the determining may be performed using the first and second channel audio responses at each of the first and second listening positions. In various examples, the first and second channel audio responses at each of the first and second listening positions may be used to calculate or simulate combined audio responses at each of the listening positions, which are then assessed or valuated based on the similarity metric as a criterion.

In a further step, the determined audio signal processing parameters are provided for further processing of at least one channel audio signal. For example, the signal processing parameters may be used when broadcasting a further (system) input audio signal, such as audio content for at least one listener.

In various example, to obtain the audio responses corresponding to the different listening positions, audio response measurements may be performed. The measurements may, for example, be performed by a first microphone arranged in the first listening position, and a second microphone in the second listening position. Correspondingly, by a further microphone in each listening positions, for example using microphone arrays. The measurements can be performed to acquire measurement data from the sound field at different listening positions (e.g. based on different locations, heights or orientations) within the listening position space.

The microphones may be arranged to sample variations in ear positions due to head movements or different listener sizes. This may, for example, comprise a vertical array of microphones to acquire variations in ear height, and/or a horizontal array to acquire variations due to head rotation or lateral movement.

During the measurement process, each audio channel in the multi-channel audio system may be activated or tested individually and/or separately based on an input test audio signal, such as, for example, a swept sine wave or another suitable test signal. While each individual audio channel is active, the microphones at each listening position acquire the resulting sound field. This process is repeated for each speaker respectively audio channel of the audio system.

The acquired microphone signals are then processed to derive the combined audio response at each listening position. These audio responses may be represented in various domains, such as, for example, the time domain (impulse responses), the frequency domain (magnitude and phase responses), or other suitable representations.

The resulting measured audio responses, which represent the variations of listening experiences across the different listening positions, may form the input data for the subsequent audio signal processing parameter optimization process based on a similarity metric calculated between audio responses.

In various examples, the similarity metric represents a similarity between representations of the first audio response and the second audio response over at least a part of the predetermined frequency range.

In various examples, the similarity metric represents a similarity between audio response characteristics of the first audio response and the second audio response over at least a part of the predetermined frequency range.

In various examples, the first and second audio responses and/or the first and second channel audio responses may comprise one or more of: a magnitude response in the frequency domain; and/or a phase response in the frequency domain; and/or an impulse response in the time domain.

These representations, or examples, of audio responses are described as exemplary options for representing the audio responses, e.g. in a domain that is suitable for representing and processing the audio response characteristics of each audio response. Each of these representations may represent the behavior of the audio system and may be used for optimization of audio signal processing parameters.

For example, the magnitude response in the frequency domain may provide a representation how the amplitude of the audio signal varies across different frequencies. This representation may be useful for identifying frequency-dependent variations in the audio response, such as resonances or attenuations, which may affect the tonal balance and timbre of the sound. By comparing the magnitude responses between different listening positions or speakers, the optimization process may aim to minimize these variations and achieve a more consistent frequency response across the listening positions.

For example, the phase response in the frequency domain may provide a representation how the phase of the audio signal varies across different frequencies. This representation may be important for analyzing the time alignment and coherence of the audio signals arriving at each listening position. Differences in phase response between speakers or listening positions may result in destructive interference, leading to a degraded audio experience. By considering the phase response, the optimization process may seek to align the phases of the audio signals and ensure a more balanced sound field across listening positions.

For example, the impulse response in the time domain may provide a representation of how the audio system responds to a short, impulsive input signal. It may show the temporal characteristics of the audio response, such as the arrival time of direct sound, early reflections, and reverberation. Analyzing the impulse responses may help in identifying time-based anomalies, such as echoes or delays, which may negatively impact the clarity and localization of the audio. The optimization process may use the impulse responses to fine-tune the time alignment and spatial characteristics of the audio system.

In various examples, a variety of other representations of audio responses may be used, for example Power Spectral Density (PSD), Time-Frequency Representations, Spectrograms, spatial parameters representing the spatial characteristics of the audio response, Binaural Representations, and other perceptual parameters, without limitation.

For example, neural networks may be used to process and compare the audio responses or representations. One common approach may be to use a neural network to generate an embedding, i.e. a lower-dimensional representation of the audio response or representation of audio response, which represents the features and characteristics of the input audio response. To compare audio responses or respective representations (e.g. spectrograms), the audio response or representation may be input into the neural network which outputs an embedding vector for each audio response. The similarity between different audio samples can then be measured by comparing the respective embedding vectors, often using a common metric like cosine similarity or Euclidean distance. Audio samples that are more similar will have embedding vectors that are closer together. For example, convolutional and recurrent neural network architectures can be commonly used for such an embedding task.

It would also be possible to use two or more different audio response representations, or a combination or concatenation of different audio response representations, for the optimization process according to the present disclosure.

In various examples, the similarity metric may represent a similarity between audio response characteristics of the respective audio responses.

The similarity metric may compare specific characteristics and/or features of the audio response. The similarity metric may quantify a similarity or differences of respective features and/or characteristics. These audio response features and/or characteristics may refer to perceptually relevant aspects of the representations.

By considering the similarity between audio response characteristics, the optimization process may be based on a subset of the data, or in other words only on characteristic features of the representations, such as based on a statistical analysis, or a features analysis, or embedding, of the audio responses or representations, instead of the raw measurement data or full representation.

For example, the audio response characteristics may comprise a signal envelope of the respective audio responses or representations of audio responses.

The signal envelope may refer to the overall shape or contour of the audio response or representation. It may represent how the amplitude or energy of the audio signal varies over the x-axis. The envelope may represent development characteristics of the audio response.

In various examples, each of the first and second listening positions may comprise one or more of a listener's head position with respect to the plurality of speakers, and/or a listener's head orientation with respect to the plurality of speakers, or a combination thereof.

The listening positions, in this context, may also refer to the spatial locations and orientations or specific geometries of a listener's head or ears relative to the speakers and/or the listening environment. The head position and orientation may represent the physical coordinates of the listener's ears within the listening environment, typically defined in a three-dimensional space. For example, a listening position may represent the listener's head's location and orientation. The head position may represent the physical coordinates of the listener's head within the listening environment. The head orientation may describe the rotational angles of the listener's head with respect to a reference direction or system, such as a coordinate system of the speaker setup and/or the listening environment or audio system.

In various examples, the similarity metric may be a numerical value calculated based on a mathematical operation applied to the first audio response and the second audio response over at least the part of the predetermined frequency range, where the mathematical operation quantifies a relationship between the first audio response and the second audio response.

The similarity metric may be a quantitative measure that represents the degree of similarity or difference between the first and second audio responses. It may be obtained by performing a mathematical calculation using the audio responses over a specific frequency range of interest.

The mathematical operation used to compute the similarity metric may involve comparing corresponding values or features of the two audio responses at each frequency point within the considered range. This operation may quantify the relationship or similarity between the audio responses by measuring their alignment, correlation, or statistical dependence.

Various mathematical techniques may be employed to calculate the similarity metric, depending on the specific characteristics of the audio responses and the desired comparison criteria. Some common approaches may include correlation analysis, coherence estimation, distance metrics, or statistical similarity measures. Calculating may be based on representations or embeddings/encodings of each audio response, for example generated by neural networks.

For example, a correlation coefficient may be calculated to measure the linear dependence between the two audio responses, indicating how they vary relative to each other over the frequency range. As a similarity metric, for example, also an Euclidean distance or another divergence measure may be used to quantify the dissimilarity between the responses based on their absolute differences or statistical properties.

The resulting similarity metric may provide a compact and interpretable representation of the similarity relationship between the audio responses.

By expressing the similarity as a numerical value, the optimization process may leverage quantitative techniques to improve the audio reproduction across different listening positions. The similarity metric may serve as a figure of merit or an objective function to be maximized or minimized during the optimization, guiding the adjustment of audio processing parameters to achieve the desired level of similarity between the responses.

Using a mathematical operation to calculate the similarity metric may provide the ability to quantify the similarity relationship between audio responses objectively for efficient computation and optimization.

In various examples, the mathematical operation may be a cross-correlation operation, and the similarity metric may comprise a cross-correlation coefficient calculated between the first audio response and the second audio response over the at least part of the predetermined frequency range.

The cross-correlation operation may refer to a mathematical technique that measures the similarity or dependence between two signals, in other words series of measurement values, as a function of the displacement or lag between them. In the context of comparing audio responses, the cross-correlation operation may involve shifting one audio response relative to the other and calculating the similarity at each shift or lag.

The cross-correlation coefficient, which results from the cross-correlation operation, may provide a normalized measure of the similarity between the two audio responses. It may quantify the degree to which the responses are aligned or correlated with each other over the considered frequency range.

Calculating the cross-correlation coefficient may involve multiplying the corresponding values of the two audio responses at each frequency point and summing the products across the frequency range. The resulting coefficient may range from −1 to +1, where a value of +1 indicates a perfect positive correlation (i.e., the responses are identical), a value of −1 indicates a perfect negative correlation (i.e., the responses are opposite), and a value of 0 indicates no correlation (i.e., the responses are uncorrelated).

The cross-correlation operation may be particularly suitable for comparing audio responses because it can represent both the magnitude and phase relationships between the audio responses. It may consider not only the similarity in the overall shape or pattern of the responses but also the relative timing or delay between them.

By using the cross-correlation coefficient as the similarity metric, the optimization process may aim to maximize the correlation between the audio responses at different listening positions. A higher cross-correlation coefficient may indicate a stronger similarity or alignment between the responses, suggesting a more consistent and balanced audio reproduction across the listening positions.

In other words, the numerical value representing the similarity score between the first and second audio responses, may be referred to as correlation score, similarity index, or coherence measure. These terms may be used interchangeably to describe the quantitative measure of the similarity between the audio responses based on the mathematical (similarity) operation.

Using the cross-correlation coefficient as the similarity metric may represent both magnitude and phase relationships, its normalized nature, and its widespread use in signal processing and audio analysis.

In preferred examples, similarity measures for unique pairs of audio responses at three or more different listening positions may be calculated and accumulated, as will be explained in more detail in the following.

In a further step, at least one third audio response may be obtained at a third listening position of the plurality of listening positions, which is different from the first and second listening positions.

The audio signal processing parameters may be determined based on a similarity metric calculated between the at least one first, at least one second, and at least one third audio responses, over at least a part of the predetermined frequency range.

The similarity metric may comprise an accumulated similarity metric based on pair-wise similarity metrics calculated between unique pairs of the at least one first, at least one second, and at least one third audio responses.

The process of obtaining the audio response at the third position is similar to that described for the first and second listening positions, involving measuring the contributions from each speaker separately and then combining them. Obtaining the at least one third audio response at the third listening position may comprise the following steps. A first channel audio response may be obtained at the third listening position, based on the first channel audio signal output by the at least one first speaker of the plurality of speakers. Separately from the first channel audio response, a second channel audio response may be obtained at the third listening position, based on the second channel audio signal output by the at least one second speaker of the plurality of speakers. The first channel audio response and the second channel audio response at the third listening position may be combined to generate the third audio response at the third listening position.

The similarity metric may represent a similarity between the audio responses at all three listening positions, over at least a portion of the frequency range. This metric quantifies how similar the three audio responses are at the respective listening positions. Specifically, the method calculates pair-wise similarity metrics between each unique pair of audio responses (first and second, first and third, second and third). These pair-wise metrics are then combined, for example summed, into an accumulated similarity metric, which provides an overall measure of the similarity of the audio responses across all three listening positions.

In various examples, the similarity metric may comprise an accumulated similarity metric based on at least two pair-wise calculated similarity metrics between different pairs of audio responses.

In various examples, the accumulated similarity metric may be calculated based on unique pairs of the first, second and third audio responses.

In case that more measurements are made to determine further audio responses for further listening positions, similarity metrics can be calculated between unique pairs of any two audio responses.

The accumulated similarity metric may be a measure that takes into account the similarities between all unique pairs, or in general at least a subset of all possible unique pairs, of audio responses across the different listening positions. It may involve calculating individual similarity metrics for each unique pair of responses and then combining them into a single accumulated metric.

For example, the process of calculating the accumulated similarity metric may start by identifying a plurality of (or optionally all) unique pairs, of audio responses (or of individual channel audio responses in general) i.e. of combined audio responses at each listening position.

For each unique pair of audio responses, a pair-wise similarity metric may be calculated, as described herein for the first and second audio responses. For example using a suitable mathematical operation, such as cross-correlation or a distance measure based on a embedding. These pair-wise similarity metrics may quantify the similarity or correspondence between each individual pair of responses.

Generally, it will be understood that not all unique pairs of audio responses need to be taken into account, wherein for example also only a representative subset, or representative combination of audio responses, or a number of pairs up to a predetermined threshold could be used.

Once the pair-wise similarity metrics are obtained, they may be combined or accumulated to form the overall accumulated similarity metric. This accumulation process may involve one or more of various mathematical operations, such as, for example, summing, averaging, or weighted averaging of the individual pair-wise metrics.

The resulting accumulated similarity metric may provide an improved measure of the overall similarity or consistency of the audio responses across all the speakers and listening positions. It may represent the collective similarity of the audio responses, taking into account the relationships between all the unique pairs.

The accumulated similarity metric may also be referred to as overall or global similarity metric or measure, which represents an aggregated similarity of all measured audio responses, wherein it quantities a similarity between all audio responses.

Using an accumulated similarity metric may provide a more robust and representative assessment of the overall audio reproduction quality across multiple speakers and listening positions. By taking into account the similarities between the individual unique pairs of responses, it may characterize more reliably the audio system's performance, in order to be used as measure for optimize the audio signal processing parameters.

In various examples, the accumulated similarity metric may comprise a combination of the pair-wise calculated similarity metrics.

The accumulated similarity metric, as discussed herein, may be obtained by combining the individual pair-wise similarity metrics between the audio responses. This combination process may involve aggregating or fusing the pair-wise metrics into a single measurement value or data structure.

There are various ways in which the pair-wise similarity metrics may be combined to form the accumulated similarity metric. One common approach may be to calculate the arithmetic mean or average of all the pair-wise metrics. This could involve summing up the individual metrics and dividing the sum by the total number of unique pairs.

Another approach may be to use a weighted average, where each pair-wise similarity metric is assigned a specific weight before being combined. The weights may reflect the relative importance or significance of each pair of audio responses in the overall assessment of similarity. For example, the weights may be based on the spatial relationship between the speakers and listening positions or on the perceptual relevance of certain frequency ranges.

Alternative combination methods may include geometric mean, harmonic mean, or other statistical measures that aim to represent the central tendency or representative value of the pair-wise similarity metrics. The choice of the combination method may depend on the specific requirements of the audio system, the desired properties of the accumulated similarity metric, and the characteristics of the pair-wise metrics themselves.

Regardless of the specific combination method used, the resulting accumulated similarity metric may provide a single representation or value that represents the overall similarity of the audio responses across all the speakers and listening positions. It may serve as a measure of the audio system's performance in terms of reproducing a balanced sound field across listening positions.

In other words, the combination of pair-wise similarity metrics may be referred to aggregation of pair-wise metrics, fusion of pair-wise metrics, or integration of pair-wise metrics, which emphasize the process of bringing together the individual metrics into a unified measure.

Combining the pair-wise similarity metrics into an accumulated similarity metric may provide a more compact and interpretable representation of the overall audio similarity. By condensing the multiple pair-wise metrics into a single value, it may simplify the optimization process and facilitate the comparison and evaluation of different audio system configurations or parameter settings.

In various examples, the accumulated similarity metric may comprise a weighted combination of the pair-wise calculated similarity metrics, wherein each pair-wise similarity metric is multiplied by a respective weighting factor.

The accumulated similarity metric, as mentioned herein, may be obtained by combining the individual pair-wise similarity metrics between individual pars of audio responses. The combination process may involve assigning different weights or importance factors to each pair-wise metric before aggregating them.

The weighting factors may be numerical values that reflect the relative significance or relevance of each pair of audio responses in the overall assessment of similarity. These factors may be determined based on various criteria, such as the spatial relationship between the speakers and listening positions, the perceptual importance of certain frequency ranges, or the desired emphasis on specific aspects of the audio reproduction.

Similarly, pair-wise similarity metrics calculated over frequency ranges that are more critical for human auditory perception may be given higher weights compared to those from less perceptually relevant frequencies. This may ensure that the accumulated similarity metric emphasizes the similarity in the frequency regions that matter most to the listeners.

The process of applying the weighting factors may involve multiplying each pair-wise similarity metric by its corresponding weight. This multiplication operation may scale the individual metrics according to their assigned importance. The weighted pair-wise metrics may then be combined using a suitable aggregation method, such as summing or averaging, to obtain the final accumulated similarity metric.

In various examples, the determining of the audio signal processing parameters may be performed as an optimization process. The optimization process may be an iterative optimization process.

For example, the optimization process iteratively adapts the audio signal processing parameters and applies these adapted parameters to at least one channel audio signal. The purpose of this iterative adaptation is to simulate adapted first and second audio responses, in general adapted audio responses at each listening positions, based on the individually measured channel audio responses.

For example, the optimization process may begin with an initial set of audio signal processing parameters, which are applied to at least one channel audio signal, wherein the audio signal processing parameters are used to modify or manipulate the audio signal of at least one channel.

After applying the audio signal processing parameters to the channel audio signal(s), the method determines adapted first and second audio responses at the first respectively second listening positions based on the adapted at least one channel audio signal. These adapted audio responses are calculated or derived using the individually measured channel audio responses, which refer to the audio responses that were measured separately for each individual channel or speaker. By applying the adapted parameters to the channel audio signal(s) and using the individually measured channel audio responses, the method calculates the adapted first and second audio responses.

Once the adapted first and second audio responses are determined, they are assessed using the similarity metric, which is a measure that quantifies the similarity or difference between the adapted first and second audio responses. By assessing the adapted audio responses using the similarity metric, the method can evaluate how well the adapted parameters have aligned or matched the audio responses across different channels or speakers

Based on the assessment using the similarity metric, the optimization process iteratively adapts the audio signal processing parameters. If the similarity metric indicates that the adapted audio responses are not sufficiently similar or aligned, the optimization process adjusts the audio signal processing parameters in an attempt to improve the similarity. This iterative adaptation continues until a satisfactory level of similarity is achieved or until a certain stopping criterion is met, such as a maximum number of iterations or a threshold for the similarity metric.

The aim of such an optimization process is to find the optimal set of audio signal processing parameters that maximize the similarity between the adapted first and second audio responses. By iteratively adapting the parameters and assessing the resulting audio responses using the similarity metric, the method provides a balanced and consistent audio reproduction across different channels or speakers.

The optimization process may optimize the audio signal processing parameters based on a loss function comprising the similarity metric.

The process of determining the optimal audio signal processing parameters may involve an iterative approach, where the parameters are gradually adjusted and refined until a desired level of similarity between the audio responses is achieved. This optimization process may be guided by a loss function that includes or uses the similarity metric.

The loss function may be a mathematical expression, based on the similarity metric, that quantifies the dissimilarity or discrepancy between the audio responses at different listening positions. It may serve as a measure of how well the current set of audio signal processing parameters achieves the desired goal of consistent audio reproduction across the listening area.

The similarity metric, which represents the similarity or correlation between the audio responses, may be included in the loss function as a term to be minimized. By minimizing the loss function, the optimization process aims to find the audio signal processing parameters that result in the highest similarity or the least dissimilarity between the responses.

For example, an iterative optimization process may be described with the following steps: Initialize the audio signal processing parameters to some starting values. Calculate the audio responses at the listening positions based on the current parameters. Compute the similarity metric and evaluate the loss function. Adjust the audio signal processing parameters in a direction that minimizes the loss function. Repeat steps 2-4 until a stopping criterion is met, such as reaching a maximum number of iterations or achieving a satisfactory level of similarity between the audio responses.

At each iteration, the optimization algorithm may use techniques such as gradient descent, simulated annealing, or evolutionary algorithms to update the audio signal processing parameters based on the gradient or direction of improvement of the loss function. The specific optimization technique used may depend on the nature of the parameters, the complexity of the loss function, and the desired convergence properties.

In other words, iterative optimization process may be referred to as adaptive audio signal processing parameter adjustment, where the parameters are continuously updated to improve the audio reproduction quality at each of the listening positions.

Using an iterative optimization process based on a loss function may provide a automated way to find the optimal audio signal processing parameters. By iteratively adjusting the parameters and evaluating the similarity metric, the optimization process may efficiently explore the parameter space and converge towards a configuration that maximizes the overall audio similarity across the listening positions. This may lead to a more consistent audio experience for the listeners.

In various examples, the optimization process may be a gradient-based optimization process.

The optimization process for determining the audio signal processing parameters may rely on gradient information to guide the search towards the optimal solution. Gradient-based optimization may be referred to as a class of algorithms that use the gradient or derivative of the loss function to determine the direction and magnitude of parameter updates.

In the context of audio signal processing, the gradient may represent the sensitivity of the loss function to changes in each audio signal processing parameter. It may indicate how small adjustments to the parameters affect the similarity metric and, consequently, the overall audio reproduction quality.

For example, a gradient-based optimization process may involve the following steps: Compute the gradient of the loss function with respect to each audio signal processing parameter. Update the parameters in the direction of the negative gradient, which points towards the steepest descent of the loss function. Adjust the step size or learning rate to control the magnitude of the parameter updates. Repeat steps 1-3 until a stopping criterion is met, such as reaching a maximum number of iterations or achieving a satisfactory level of similarity.

Common gradient-based optimization algorithms may include, for example, gradient descent, stochastic gradient descent, or variants. Such algorithms may differ in terms of how they estimate the gradient, adapt the learning rate, or handle stochastic noise in the optimization process.

The computation of the gradient may involve techniques like numerical differentiation or automatic differentiation. Numerical differentiation approximates the gradient by evaluating the loss function at slightly perturbed parameter values, while automatic differentiation uses symbolic or algorithmic techniques to compute the gradient efficiently.

The gradient-based optimization may also be referred to as gradient descent optimization, or derivative-based optimization, wherein gradient information is used to guide the determining of new audio signal processing parameter sets.

Using a gradient-based optimization process may provide an efficient approach to finding the optimal audio signal processing parameters. By leveraging gradient information, the optimization algorithm can take informed steps towards minimizing the loss function and improving the audio similarity. Gradient-based methods often exhibit faster convergence compared to gradient-free methods, especially when the parameter space is high-dimensional.

In an optimization phase, a first set of audio signal processing parameters may be determined or optimized. In a further optimization phase, based on or using the first set of audio signal processing parameters, a second set of audio signal processing parameters may be determined or optimized. However, it is to be understood that both sets of audio signal processing parameters can also be optimized independently of each other.

In various examples, the audio signal processing parameters may comprise at least a first set of audio signal processing parameters, which specify at least a first time delay applied to a first channel audio signal relative to at least one other channel audio signal.

The audio signal processing parameters that are being optimized may include a first set of parameters related to time delays between different channel audio signals. These time delay parameters may be used to adjust the relative timing or alignment of the audio signals across different speakers or channels.

In particular, the first set of audio signal processing parameters may specify a time delay that is applied to a specific channel audio signal, referred to as the first channel audio signal. This delay may be measured relative to one or more other channel audio signals in the audio system.

The time delay may, for example, be expressed as a time duration, in terms of samples, milliseconds, or any other suitable unit of time. It may represent the amount of time by which the first channel audio signal is shifted or delayed compared to another (reference) channel audio channel signal, or the input audio signal.

Applying time delays to individual channel audio signals may help in achieving a desired spatial alignment or synchronization between the speakers. By adjusting the relative delays, the audio system can compensate for differences in the distances between the speakers and the listening positions, ensuring that the sound from different speakers arrives at the listeners' ears at the appropriate times.

Time delay parameters may also be referred to as inter-channel delay or channel alignment delay parameters, which represents the temporal relationship or alignment between different channel audio signals.

Including channel time delay parameters in the audio signal processing optimization may enable the audio system to create a more balanced sound field, in a first step, with a relatively low number of optimized parameters, i.e. the parameters that describe channel delays for one, or more, or (all-1) channel audio signals.

In various examples, the audio signal processing parameters may comprise at least a second set of audio signal processing parameters including filter parameters of at least one frequency-dependent phase-modifying filter applied to at least one channel audio signal.

The audio signal processing parameters being optimized may also include a second set of parameters related to frequency-dependent phase-modifying filters to be applied to the individual channel audio signals. These filters may be applied to one or more channel audio signals to modify their phase response in a frequency-specific manner, i.e. within a specific frequency region.

The second set of audio signal processing parameters may specify the characteristics and settings of the phase-modifying filters. These filter parameters may include coefficients, cut-off frequencies, Q-factors, or any other relevant parameters that define the behavior of the filters.

The phase-modifying filters may be designed to introduce frequency-dependent phase shifts to the audio signals. By altering the phase response of specific frequency components, these filters can help in achieving a desired phase alignment or coherence between different channel audio signals.

For example, the phase-modifying filters may be used to compensate for phase mismatches or inconsistencies that occur due to the physical placement of speakers or the acoustic properties of the listening environment. By carefully adjusting the phase response of certain frequency ranges, the filters can help in creating a more balanced sound field.

Frequency-dependent phase-modifying filters may also be referred to as phase equalizers, phase alignment filters, or phase correction filters. These terms may emphasize the purpose or function of the filters in modifying the phase of the audio signals within specified frequency regions mainly or only.

Incorporating frequency-dependent phase-modifying filters in the audio signal processing optimization may allow for a more precise and targeted control over the phase characteristics of the audio system. By selectively modifying the phase response at different frequencies for specific audio channels, the filters can help in achieving a more balanced and balanced sound reproduction across the listening positions.

For example, the choice of filter type (e.g., all-pass filters, fractional delay filters) and the number of filters applied to each channel audio signal, and which channels, may depend on the specific audio system.

In various examples, the frequency-dependent phase-modifying filter may be configured to modify a phase spectrum in a frequency region of the predetermined frequency range of the at least one channel audio signal without substantially modifying its amplitude spectrum.

In various examples, the frequency-dependent phase-modifying filter may be configured to modify a phase spectrum in a frequency region of the predetermined frequency range of the at least one channel audio signal without substantially modifying its amplitude spectrum.

In various examples, the filter parameters may at least define the frequency region where the frequency-dependent phase-modifying filter is to be applied and a phase shift to be applied within the frequency region.

In various examples, the phase-modifying filter may be an all-pass filter, and the filter parameters may comprise one or more of: a center frequency, a quality factor, and a phase parameter.

The phase-modifying filter as described herein may be specifically implemented as an all-pass filter. An all-pass filter may refer a type of filter that has a flat magnitude response across all frequencies but introduces a frequency-dependent phase shift. This means that the filter does not attenuate or amplify any frequency components but instead alters their phase relationships.

The behavior of the all-pass filter may be controlled by a set of filter parameters. These parameters may include a center frequency, which determines the frequency at which the maximum phase shift occurs, wherein it specifies the central point or peak of the phase modification curve, a quality factor (Q-factor), which specified to the bandwidth or sharpness of the phase modification curve, wherein. a higher Q-factor results in a narrower frequency range affected by the phase shift, while a lower Q-factor leads to a broader frequency range, and a phase parameter, which specifies an amount or degree of phase shift introduced by the all-pass filter, and which determines how much the phase of the frequency components around the center frequency is altered.

By adjusting these filter parameters, it becomes possible to control the specific frequency region where the phase modification takes place, the width of the affected frequency range, and the extent of the phase shift applied.

Using an all-pass filter with adjustable parameters may provide a precise and flexible means of modifying the phase response of the audio signal. By carefully selecting the center frequency, Q-factor, and phase parameter, the audio engineer can target specific frequency regions and apply the desired amount of phase shift to achieve the intended phase alignment or coherence between different channel audio signals.

In general, the phase-modifying filter applied to the channel audio signal may be designed to selectively alter the phase response within a specific frequency region of interest. This frequency region may be a subset of the overall predetermined frequency range of the audio signal.

A key characteristic of the phase-modifying filter may be that it modifies the phase spectrum of the audio signal without significantly affecting its amplitude spectrum. In other words, the filter may introduce phase shifts to certain frequency components while preserving the overall magnitude or energy of those components.

This selective phase modification may be achieved through the use of all-pass filters or other specialized filter structures that have a flat magnitude response but a non-linear phase response. These filters may be designed to provide the desired phase shift at specific frequencies or frequency ranges while minimally impacting the amplitude of the signal.

By modifying only the phase spectrum and leaving the amplitude spectrum largely unchanged, the phase-modifying filter may help in achieving a desired phase alignment or coherence between different channel audio signals without introducing any significant spectral coloration or altering the tonal balance of the audio.

Frequency-dependent phase modification may also be referred to as frequency-selective phase shift or modification (without amplitude distortion), which may refer to modifying the phase response for certain frequencies while substantially maintaining the integrity of the amplitude spectrum.

Using a phase-modifying filter that operates on a specific frequency region without substantially modifying the amplitude spectrum may provide a targeted and transparent means of adjusting the phase characteristics of the respective channel audio signals. By preserving the original amplitude spectrum, the filter may help in maintaining the overall tonal quality and balance of the audio while still achieving the desired phase alignment or coherence.

The described optimization may provide design and parametrization of the phase-modifying filter. For example, a choice of a filter type, the definition of the frequency region, and the amount of phase shift applied can be provided.

In various examples, the method may further comprise determining the frequency region for applying the frequency-dependent phase-modifying filter based on at least the first and second audio responses.

The frequency region over which the phase-modifying filter operates may be determined by analyzing the first and second audio responses obtained from the different listening positions.

These audio responses are distorted or dissimilar due to the acoustic characteristics of the listening environment and the relative phase relationships between the different channel audio signals.

By examining the first and second audio responses, it is possible to identify the frequency regions where phase misalignments or incoherencies are most prominent. This analysis may involve comparing the phase spectra of the audio responses, looking for frequency bands where the phase differences are significant or where the phase relationships deviate.

Based on this analysis, the frequency region for applying the phase-modifying filter can be determined. The goal is to select a frequency region that encompasses the problematic areas where phase modifications are needed to improve the overall phase coherence and spatial characteristics of the audio reproduction.

Determining the frequency region based on the audio responses may allow for a computationally efficient, precise and data-driven approach for determining the phase modification filter.

In various examples, the determining of the frequency region may be performed based on a determination of at least a frequency region the first and second frequency responses are dissimilar, for example compared to an average or median of all frequency bins, or over a threshold value.

The determination of the frequency region of at least a channel audio signal for applying the phase-modifying filter may involve identifying the frequency bands, or frequency bins, where the first and second audio responses exhibit significant dissimilarities or differences.

The dissimilarity between the audio responses can be assessed, for example, by comparing their frequency-domain representations, such as magnitude or phase spectra. By analyzing the differences in these spectra across different frequency bands, it is possible to locate the regions where the audio responses deviate from each other, indicating potential phase misalignments or incoherencies.

The frequency bands where the dissimilarities are present can be regarded candidate frequency regions for applying phase modifications. These regions may benefit the most from phase correction to bring the audio responses into better alignment and improve the overall spatial coherence of the audio reproduction.

In this step, the frequency regions, in other words frequency bands are located that have significant differences between the first and second audio responses.

Accordingly, determining the frequency region based on the dissimilarities between the first and second audio responses provides an approach based on measured audio responses to identify the frequency bands that require phase modification. By focusing on the specific frequency regions with the most significant differences, it is possible to optimize the effectiveness of the phase-modifying filter and improve the overall spatial coherence and quality of the audio reproduction.

In various examples, determining the frequency region may comprise calculating a first-order derivative of the first audio response and of the second audio response for each of a plurality of candidate frequency regions in the predetermined frequency range. The candidate frequency regions may also be referred to as (candidate) frequency bins or (candidate) frequency bands.

The frequency region may then be selected from the candidate frequency regions using the respective first-order derivatives of the first and second audio responses at the plurality of candidate frequency regions.

In various examples, the selection of the frequency region may comprise selecting the frequency region from the candidate frequency regions based on a difference metric computed for each candidate frequency region using the first-order derivatives of the first and second audio responses.

The process of determining the frequency region for applying the phase-modifying filter may involve a more detailed analysis of the first and second audio responses. One approach is to calculate the first-order derivatives of these audio responses for a set of candidate frequency regions within the predetermined frequency range of interest.

The first-order derivative may represent the rate of change or slope of the audio response at each frequency point. By computing the first-order derivatives for representative points of each of a plurality of candidate frequency regions of both the first and second audio responses, it is possible to obtain information about how rapidly the respective audio responses are changing within each candidate frequency region.

The candidate frequency regions may be predefined or dynamically selected based on the characteristics of the audio responses. These regions represent potential frequency bands where phase modifications could be applied to improve the spatial coherence and quality of the audio reproduction.

Once the first-order derivatives are calculated for each candidate frequency region, a difference metric can be computed to quantify the dissimilarity or difference between the first and second audio responses within each region. This difference metric may take into account the magnitudes and/or directions of the first-order derivatives, providing a measure of how much the audio responses deviate from each other in terms of their rate of change.

The difference metric can then be used as a criterion for selecting the frequency region from the candidate regions. For example, the region with the highest difference metric, indicating the most significant mismatch between the audio responses, may be chosen as the optimal frequency band for applying the phase-modifying filter.

In other words, the rate of change of the audio responses or representations may be determined and analyzed within candidate frequency regions using first-order derivatives, in particular based on signal envelopes of representations for the audio responses.

Thus, it becomes possible to quantify the dissimilarity between audio responses in each candidate frequency region based on the first-order derivative information. Further, the one or more frequency regions can be selected from the candidate frequency region, which have a dissimilarity with the most pronounced mismatch between audio responses as indicated by the difference metric. The channel audio signal, or both channel audio signals, can be selected that corresponds to one or more of the analyzed audio responses. In other words, both the frequency region and the channel audio signal, to which the frequency-dependent phase-modifying filter is to be applied, can be determined based on the difference metric.

Using the first-order derivatives, and a difference metric based thereon, for frequency region selection provides a more precise and computationally efficient approach to identifying the problematic frequency bands and channel signals to be filtered. By considering the rate of change of the audio responses and comparing them across candidate regions, the audio engineer can determine the specific frequency bands where phase misalignments or incoherencies are, e.g. above a threshold and/or highest metric of all candidate frequency regions.

This approach allows for a computationally efficient, precise and measurement data-based selection of the frequency region. The difference metric may also serve as a criterion for identifying or selecting the channel audio signal for the filter.

Some frequency bands may have a higher perceptual impact on the overall audio quality than others, and this could be included by respective weighting factors in the difference metric, which represent the perceptual impact.

As described herein, using the first-order derivatives and a difference metric to determine the frequency region may provide a computationally efficient and measurement data-based approach to identifying the frequency region for applying the phase-modifying filter, and to selecting the one or more channel audio signal to which the filters are to be applied.

In various example, the second set of audio signal processing parameters also include at least one parameter, that identifies a channel audio signal, to which the frequency-dependent phase-modifying filter is to be applied.

It is to be understood that more than two, or more than three, or more than four, different frequency-dependent phase-modifying filters may be parametrized by the disclosed techniques, to be applied to at least one channel audio signal, or each of at least two, or at least three, or at least four different, or all channel audio signals. Therein, the second set of audio signal processing parameters, identifies the target audio channel signals, and parametrizes identifies these filters.

In various examples, determining the frequency region for applying the phase-modifying filter may be performed further based on the first, second and third audio responses.

Similarly to the accumulated pair-wise calculated similarity metric, which may be calculated using at least a subset of unique pairs of audio responses, also the difference metric can comprise an accumulated difference metric, that is computed based on a plurality of audio responses.

An accumulated difference metric may be calculated for each candidate frequency region using the first-order derivatives of the first, second and third audio responses. The difference metric as described herein may then comprise this accumulated difference metric.

As described for the at least one first and at least one second audio response, the determination of the frequency region for applying the phase-modifying filter may take into account not only the first and second audio responses but also at least a subset, or each of the individual channel audio responses at each listening position, in a combined approach.

According to this combined approach, the first-order derivatives are calculated for each channel audio response at the first and second listening positions, for each speaker separately. These derivatives provide information about the rate of change or slope of each speaker's audio response within the candidate frequency regions for each listening position.

An accumulated difference metric is then computed for each candidate frequency region by combining the first-order derivatives of all the channel audio responses at each listening position. This accumulated metric represents an overall measure of the dissimilarity of the channel audio responses across all listening positions.

The calculation of the accumulated difference metric may involve various mathematical operations, such as summing, averaging, or weighted combining of the individual speaker response derivatives. A weighting may be given to each speaker's contribution and the relative importance of the different listening positions.

By considering the accumulated difference metric, the determination of the frequency region can be calculated from the individual audio response measurements, and takes into account the collective behavior of all the speakers and the variations in their audio responses across the listening positions. This provides a more comprehensive assessment of the phase misalignments or incoherencies present in the audio reproduction.

This step may also be referred to as evaluating the combined dissimilarity of speaker responses across listening positions using an accumulated difference metric, or aggregating the first-order derivatives of speaker responses to quantify the overall mismatch in each candidate frequency region. The frequency region may be determined based on the accumulated difference metric, considering the contributions of all speakers at multiple listening positions.

Using the accumulated difference metric may be computationally efficient to determine from individual measurements and provides an overall assessment across the entire audio system. By considering the individual audio responses of all speakers at multiple listening positions, it is possible to identify one or more frequency regions that exhibit the most significant phase misalignments.

Based on the identified one or more frequency regions, the optimization for the second set of audio signal processing parameters, i.e. the filter parameters for the frequency-dependent phase-modifying filters, may be performed.

In various examples, the accumulated difference metric may be calculated as a product of the sum of positive values of the first-order derivatives and an absolute value of a sum of negative values of the first-order derivatives, considering the first and second channel audio responses at each of the first and second listening positions, for each of the plurality of candidate frequency regions.

The calculation of the accumulated difference metric may involve a mathematical formula that combines the positive and negative values of the first-order derivatives across all the channel audio responses and listening positions.

For each candidate frequency region, the first-order derivatives of the individual channel audio responses are computed. These derivatives are then separated into two groups: positive values and negative values. The positive values represent the derivatives that indicate an increasing trend in the audio response, while the negative values represent the derivatives that indicate a decreasing trend. The sum of the positive derivative values is calculated, and similarly, the sum of the negative derivative values is determined. The absolute value of the sum of negative derivatives is then computed to obtain a non-negative value. The accumulated difference metric is obtained by multiplying the sum of positive derivatives with the absolute value of the sum of negative derivatives. This product represents a measure of the overall dissimilarity or mismatch between the channel audio responses within the candidate frequency region.

The process is repeated for each candidate frequency region, resulting in an accumulated difference metric value for each region. These values provide a quantitative assessment of the phase misalignments or incoherencies present in each frequency band.

In various example, the candidate frequency region with the highest accumulated difference metric value may be selected as the frequency region for applying the phase-modifying filter, as it represents the region with the most significant dissimilarity between the channel audio responses.

In some examples, the selection of the frequency region may involve comparing the accumulated difference metric values to a predetermined threshold. The frequency region may be selected from the candidate frequency regions where the accumulated difference metric exceeds this threshold, indicating a significant level of dissimilarity that warrants phase modification.

The selected frequency region may be determined by considering the peak values of the accumulated difference metric. The frequency region may be centered around the peak value, ensuring that the phase-modifying filter is applied to the frequency band with the most prominent dissimilarity.

In other words, the dissimilarity metric may be calculated using a product of summed positive and negative derivatives, and the frequency region may be identified with the highest accumulated difference metric value for phase modification. Alternatively, or in addition, the frequency region may be selected based on a threshold comparison of the accumulated difference metric. The selection of an appropriate threshold value for the accumulated difference metric may require empirical determination or prior knowledge of the audio system, i.e. a predetermined threshold.

In various examples, the predetermined frequency range may cover frequencies between 10 Hz and 400 Hz.

The predetermined frequency range mentioned herein may refer to the range of frequencies of the input audio signal, or the output sound field, over which the audio analysis and phase modification processes are applied.

This frequency range is particularly relevant for low-frequency audio content, such as bass sounds, which often require careful phase alignment to achieve a balanced audio experience.

In various examples, the method may further comprise applying a global equalization filter to the input audio signal before processing the input audio signal to generate the plurality of channel audio signals.

Before the input audio signal is split into individual channel audio signals, a global equalization filter may be applied to shape the overall frequency response of the audio. This equalization process is performed prior to the phase analysis and modification steps described in the previous claims.

The global equalization filter is designed to adjust the frequency balance of the input audio signal, ensuring that it aligns with the desired tonal characteristics or target frequency response curve. This filter can be used to compensate for any inherent frequency imbalances in the audio source or to match the audio to a specific equalization standard or preference.

A corresponding audio system is provided, which is configured to perform any method or any combination of method steps, according to the present disclosure.

The audio system may comprise a processor and memory, the memory comprising instructions, which when executed by the processor, cause the processor to perform the method for determining audio signal processing parameters according to any method or combination of methods as described herein. The processor can be any suitable computing device or microprocessor capable of executing the instructions stored in the memory. The memory can be any type of computer-readable storage medium, such as RAM, ROM, flash memory, or a hard disk drive.

The audio system may further comprise a measurement system configured to measure a respective channel audio response of the multi-channel audio system at each of the listening positions with a respective microphone.

Such an audio system may refer, for example, to an audio testing system for a multi-channel audio system comprising a plurality of speakers, each configured to broadcast a respective channel audio signal to each listening position of a plurality of listening positions in a listening environment, and may comprise a computing device configured to perform any method or combination of methods for determining audio signal processing parameters according as described herein.

A computing device comprises memory and at least one processor, wherein the memory comprises program code to be executed by the at least one processor, wherein executing the program by the processor causes the computing device to perform any method or combination of methods for determining audio signal processing parameters according as described herein.

A computer program, or computer program product, comprises program code to be executed by at least one processor of a computing device. Therein, the execution of the program code causes the at least one processor to execute one of the methods according to the present disclosure.

A computer-readable storage medium comprises instructions which, when executed by a processor, cause the processor to carry out any method or combination of methods according to the present disclosure.

The disclosed techniques will be better understood in view of the following examples:

### EXAMPLES

Example 1. A computer-implemented method for adjusting audio signal processing parameters for a multi-channel audio system including a plurality of speakers, the method comprising:
obtaining at least one first audio response at a first listening position of a plurality of listening positions, wherein a respective channel audio signal based on an input audio signal over a predetermined frequency range was output by a respective speaker of the plurality of speakers in a listening environment of the multi-channel audio system;
obtaining at least one second audio response at a second listening position of the plurality of listening positions different from the first listening position;
adjusting the audio signal processing parameters based on a similarity metric calculated between the at least one first audio response and the at least one second audio response over at least a part of the predetermined frequency range; and
providing the audio signal processing parameters for further processing of at least one of the channel audio signals.

Example 2. The computer-implemented method of example 1, wherein obtaining the at least one first and the at least one second audio response comprises:
obtaining, based on a first channel audio signal output by at least a first speaker of the plurality of speakers, a respective first channel audio response at each of the first and second listening positions; and
obtaining, separately from first channel audio responses, based on a second channel audio signal output by at least a second speaker of the plurality of speakers, a respective second channel audio response at each of the first and second listening positions,
combining the first channel audio response at the first listening position and the second channel audio response at the first listening position, in order to generate the first audio response at the first listening position; and
combining the first channel audio response at the second listening position and the second channel audio response at the second listening position, in order to generate the second audio response at the second listening position;
wherein the adjusting of signal processing parameters is performed using the first and second channel audio responses and/or the first and second the channel audio signals.

Example 3. The computer-implemented method of example 2, wherein each of the first and second channel audio responses is measured based on only a respective single one of the first respectively second channel audio signals and/or the at least one first respectively at least one second speakers.

Example 4. The computer-implemented method of one of the preceding examples, wherein the first and second audio responses and/or the first and second channel audio responses comprise one or more of:
a magnitude response in the frequency domain;
a phase response in the frequency domain; and
an impulse response in the time domain.

Example 5. The computer-implemented method of one of the preceding examples, wherein the similarity metric represents a similarity between representations of the respective audio responses.

Example 6. The computer-implemented method of one of the preceding examples, wherein the similarity metric represents a similarity between corresponding audio response characteristics of the respective audio responses.

Example 7. The computer-implemented method of example 6, wherein the audio response characteristics comprise a signal envelope of the respective audio responses.

Example 8. The computer-implemented method of one of the preceding examples, wherein each of the first and second listening positions corresponds to:
a listener's head location with respect to the plurality of speakers;
a listener's head orientation with respect to the plurality of speakers; or
a combination thereof.

Example 9. The computer-implemented method of one of the preceding examples, wherein the similarity metric is a numerical value calculated based on a mathematical operation applied to the first audio response and the second audio response over at least the part of the predetermined frequency range, where the mathematical operation quantifies a similarity relationship between the first audio response and the second audio response.

Example 10. The computer-implemented method of example 9, wherein the mathematical operation is a cross-correlation operation, and the similarity metric comprises a cross-correlation coefficient calculated between the first audio response and the second audio response over the at least part of the predetermined frequency range.

Example 11. The computer-implemented method of one of the preceding examples, wherein the similarity metric comprises an accumulated similarity metric based on pair-wise similarity metrics between unique pairs of the first and second channel audio responses at each of the first and second listening positions.

Example 12. The computer-implemented method of one of the preceding examples, further comprising:
obtaining at least one third audio response at a third listening position of the plurality of listening positions different from the first and second listening positions; and
adjusting the audio signal processing parameters based on a similarity metric calculated between the at least one first, at least one second, and at least one third audio responses, over at least a part of the predetermined frequency range;
wherein the similarity metric comprises an accumulated similarity metric based on pair-wise similarity metrics calculated between unique pairs of the at least one first, at least one second, and at least one third audio responses.

Example 13. The computer-implemented method of example 12, wherein obtaining the at least one third audio response at the third listening position comprises:
obtaining, based on the first channel audio signal output by the at least one first speaker of the plurality of speakers, a first channel audio response at the third listening position; and
obtaining, separately from first channel audio response, based on the second channel audio signal output by the at least one second speaker of the plurality of speakers, a second channel audio response at the third listening position, and
combining the first channel audio response at the third listening position and the second channel audio response at the third listening position, in order to generate the third audio response at the third listening position.

Example 14. The computer-implemented method of one of examples 11 to 13, wherein the accumulated similarity metric comprises a combination of the pair-wise calculated similarity metrics.

Example 15. The computer-implemented method of example 14, wherein the accumulated similarity metric comprises a weighted combination of the pair-wise calculated similarity metrics, wherein each pair-wise similarity metric is multiplied by a respective weighting factor.

Example 16. The computer-implemented method of one of the preceding examples, wherein the adjusting of the audio signal processing parameters is performed as an iterative optimization process on the audio signal processing parameters based on a loss function comprising the similarity metric.

Example 17. The computer implemented method of example 16, wherein the optimization process comprises iteratively adapting the audio signal processing parameters and applying the adapted audio signal processing parameters to at least one channel audio signal, in order to determine adapted first and second audio responses using on the individually measured channel audio responses, and assessing the first and second audio responses based on the similarity metric.

Example 18. The computer-implemented method of example 16 or 17, wherein the optimization process is a gradient-based optimization process.

Example 19. The computer-implemented method of one of the preceding examples, wherein the audio signal processing parameters comprise at least a first set of audio signal processing parameters, which specify at least a first time delay to be applied to a first channel audio signal relative to at least one other channel audio signal.

Example 20. The computer-implemented method of one of the preceding examples, wherein the audio signal processing parameters comprise at least a second set of audio signal processing parameters including filter parameters of at least one frequency-dependent phase-modifying filter applied to at least one channel audio signal.

Example 21. The computer-implemented method of example 20, wherein the frequency-dependent phase-modifying filter is configured to modify a phase spectrum in a frequency region of the predetermined frequency range of the at least one channel audio signal without substantially modifying its amplitude spectrum.

Example 22. The computer-implemented method of example 21, wherein the filter parameters at least define the frequency region where the frequency-dependent phase-modifying filter is to be applied and a phase shift to be applied within the frequency region.

Example 23. The computer-implemented method of one of examples 20 to 22, wherein the phase-modifying filter is an all-pass filter, and the filter parameters comprises one or more of: a centre frequency, a quality factor, and a phase parameter.

Example 24. The computer-implemented method of one of examples 20 to 23, further comprising:
determining the frequency region for applying the frequency-dependent phase-modifying filter based on at least the first and second audio responses.

Example 25. The computer-implemented method of one of examples 20 to 24, further comprising:
determining the channel audio signal for applying the frequency-dependent phase-modifying filter based on at least the first and second audio responses.

Example 26. The computer-implemented method of example 24 or 25, wherein the determining the frequency region is performed based on a determination of where the first and second frequency responses are dissimilar.

Example 27. The computer-implemented method of any of examples 24 to 26, wherein determining the frequency region comprises:
calculating a first-order derivative of the first audio response and the second audio response for each of a plurality of candidate frequency regions in the predetermined frequency range; and
selecting the frequency region from the candidate frequency regions using the respective first-order derivatives of the first and second audio responses at the plurality of candidate frequency regions.

Example 28. The computer-implemented method of example 27, wherein selecting the frequency region comprises:
selecting the frequency region from the candidate frequency regions based on a difference metric computed for each candidate frequency region using the first-order derivatives of the first and second audio responses.

Example 29. The computer-implemented method of examples 24 to 28,
wherein determining the frequency region for applying the phase-modifying filter is performed further based on the third audio response at the third listening position.

Example 30. The computer-implemented method of example 29, further comprising:
calculating an accumulated difference metric for each candidate frequency region using the first-order derivatives of the of the first, second and third audio responses, wherein the difference metric comprises the accumulated difference metric.

Example 31. The computer-implemented method of example 30, wherein the accumulated difference metric is calculated using a mathematical combination of values of the first-order derivatives of the first and second channel audio responses at each of the plurality of candidate frequency regions.

Example 32. The computer-implemented method of example 31, wherein the accumulated difference metric is calculated as:
a product of the sum of positive values of the first-order derivatives and an absolute value of a sum of negative values of the first-order derivatives, of the first, second and third audio responses, at each of the plurality of candidate frequency regions.

Example 33. The computer-implemented method of one of examples 27-32, wherein the selecting the frequency region comprises:
selecting the frequency region from the candidate frequency regions, where the difference metric exceeds a predetermined threshold.

Example 34. The computer-implemented method of one of examples 28-33, wherein the frequency region is a frequency region centred around a peak in the difference metric.

Example 35. The computer-implemented method of one of the preceding examples, wherein the predetermined frequency range covers frequencies in a range between 10 Hz and 400 Hz.

Example 36. The computer-implemented method of one of the preceding examples, further comprising:
applying a global equalization filter to the input audio signal before processing the input audio signal to generate the plurality of channel audio signals.

Example 37. A system comprising a processor and memory, the memory comprising instructions, which, when executed by the processor, cause the processor to perform the method for determining audio signal processing parameters for a multi-channel audio system according to the method of one of examples 1 to 36.

Example 38. The system of example 37, further comprising:
the multi-channel audio system comprising a plurality of speakers, each configured to broadcast a respective channel audio signal to each listening position of a plurality of listening positions in a listening environment; and
a measurement system configured to measure a respective channel audio responses of the multi-channel audio system at each of the listening positions with a respective microphone.

Summarizing, the present disclosure relates to a computer-implemented method for adjusting audio signal processing parameters for a multi-channel audio system comprising a plurality of speakers. The method aims to optimize the audio signal processing parameters to achieve a consistent and balanced sound field across multiple listening positions.

The method involves obtaining at least one first audio response at a first listening position and at least one second audio response at a second listening position, where each audio response is based on a respective channel audio signal output by a respective speaker over a predetermined frequency range. The audio signal processing parameters are then determined by calculating a similarity metric between the first and second audio responses over at least a part of the predetermined frequency range.

The similarity metric represents the degree of similarity between the audio responses and may be based on various mathematical operations, such as cross-correlation, mean squared error, or cosine similarity. The method may also involve obtaining audio responses at additional listening positions and calculating an accumulated similarity metric based on pair-wise comparisons between the audio responses.

The determination of the audio signal processing parameters is performed as an optimization process, such as a gradient-based optimization, which iteratively adjusts the parameters to maximize the similarity metric or minimize a loss function based on the similarity metric. The audio signal processing parameters may include channel delay parameters, which specify time delays to be applied to individual channel audio signals, and filter parameters for frequency-dependent phase-modifying filters, such as all-pass filters, applied to one or more channel audio signals.

The method may further include determining the frequency regions for applying the phase-modifying filters based on the dissimilarity between the audio responses, using techniques such as first-order derivative analysis and peak picking. The optimization process may be performed over a predetermined frequency range, such as a low-frequency range, to focus on improving the bass response consistency across listening positions.

The present disclosure further provides a computing device and a multi-channel audio system configured to perform the disclosed methods. By utilizing the similarity metric-based optimization approach, the embodiments of the disclosure provide an efficient and effective way to achieve a balanced and consistent sound field across multiple listening positions in a multi-channel audio system.

What is claimed is:

1. A computer-implemented method for determining audio signal processing parameters for a multi-channel audio system including a plurality of speakers, the computer-implemented method comprising:
obtaining at least one first audio response at a first listening position of a plurality of listening positions;
obtaining at least one second audio response at a second listening position of the plurality of listening positions, the second listening position being different from the first listening position, wherein a respective channel audio signal based on an input audio signal over a predetermined frequency range was output by a respective speaker of the plurality of speakers in a listening environment of the multi-channel audio system;
determining the audio signal processing parameters based on a similarity metric calculated between the at least one first audio response and the at least one second audio response over at least a part of the predetermined frequency range; and
providing the audio signal processing parameters for further processing of the respective channel audio signal.

2. The computer-implemented method of claim 1, wherein obtaining the at least one first audio response and the at least one second audio response comprises:
obtaining, based on a first channel audio signal output by at least a first speaker of the plurality of speakers, a first channel audio response at each of the first listening position and the second listening position; and
obtaining, separately from first channel audio responses, based on a second channel audio signal output by at least a second speaker of the plurality of speakers, a second channel audio response at each of the first listening position and the second listening position,
combining the first channel audio response and the second channel audio response at the first listening position, in order to generate the at least one first audio response; and
combining the first channel audio response and the second channel audio response at the second listening position, in order to generate the at least one second audio response;
wherein determining the audio signal processing parameters is further performed using the first channel audio signal output and the second channel audio signal output at each of the first listening position and the second listening position.

3. The computer-implemented method of claim 1, wherein the at least one first audio response and the at least one second audio response comprise one or more of:
a magnitude response in a frequency domain;
a phase response in the frequency domain; or
an impulse response in a time domain.

4. The computer-implemented method of claim 1, wherein the similarity metric represents a degree of a similarity between the at least one first audio response and the at least one second audio response.

5. The computer-implemented method of claim 1, wherein the similarity metric comprises a numerical value, specifically a cross-correlation coefficient, calculated based on a cross-correlation operation applied to the at least one first audio response and the at least one second audio response over at least the part of the predetermined frequency range, where the cross-correlation operation quantifies a similarity relationship between the at least one first audio response and the at least one second audio response.

6. The computer-implemented method of claim 1, further comprising:
obtaining at least one third audio response at a third listening position of the plurality of listening positions, the third listening position being different from the first listening position and the second listening position; and
determining the audio signal processing parameters based on a similarity metric calculated between the at least one first audio response, the at least one second audio response, and the at least one third audio response, over at least a part of the predetermined frequency range;
wherein the similarity metric comprises an accumulated similarity metric based on a combination of pair-wise calculated similarity metrics calculated between unique pairs of the at least one first audio response, the at least one second audio response, and the at least one third audio response.

7. The computer-implemented method of claim 6, wherein the accumulated similarity metric comprises a weighted combination of the pair-wise calculated similarity metrics, wherein each pair-wise similarity metric is multiplied by a respective weighting factor.

8. The computer-implemented method of claim 2, wherein determining of the audio signal processing parameters is performed as a gradient-based optimization process of the audio signal processing parameters based on a loss function comprising the similarity metric calculated using the first channel audio response and the second channel audio response at the first listening position and the second listening position.

9. The computer-implemented method of claim 1, wherein the audio signal processing parameters comprise at least a first set of audio signal processing parameters, which specify at least a first time delay to be applied to a first channel audio signal relative to at least one other channel audio signal.

10. The computer-implemented method of claim 1, wherein the audio signal processing parameters comprise at least a second set of audio signal processing parameters including filter parameters of at least one frequency-dependent phase-modifying filter applied to at least one channel audio signal.

11. The computer-implemented method of claim 10, wherein the at least one frequency-dependent phase-modifying filter is configured to modify a phase spectrum in a frequency region of the predetermined frequency range of the at least one channel audio signal without substantially modifying an amplitude spectrum of the at least on channel audio signal.

12. The computer-implemented method of claim 10, wherein the at least one frequency-dependent phase-modifying filter is an all-pass filter, and the filter parameters comprise one or more of a center frequency, a quality factor, and a phase parameter of the all-pass filter.

13. The computer-implemented method of claim 11, further comprising:
determining the frequency region for applying the at least one frequency-dependent phase-modifying filter based on a determination of where a first frequency response and a second frequency response are dissimilar.

14. The computer-implemented method of claim 13, wherein determining the frequency region comprises:
calculating a first-order derivative of the at least one first audio response and the at least one second audio response for each candidate region of a plurality of candidate frequency regions in the predetermined frequency range; and
selecting the frequency region from the plurality of candidate frequency regions based on a difference metric computed for each candidate frequency region from the plurality of candidate frequency regions using first-order derivatives of the at least one first audio response and the at least one second audio response at the plurality of candidate frequency regions.

15. A computing device comprising:
a processor; and
memory, the memory comprising instructions, which, when executed by the processor, cause the processor to perform a method for determining audio signal processing parameters for a multi-channel audio system comprising the steps of:
obtaining at least one first audio response at a first listening position of a plurality of listening positions;
obtaining at least one second audio response at a second listening position of the plurality of listening positions, the second listening position being different from the first listening position, wherein a respective channel audio signal based on an input audio signal over a predetermined frequency range was output by a respective speaker of a plurality of speakers in a listening environment of the multi-channel audio system;
determining the audio signal processing parameters based on a similarity metric calculated between the at least one first audio response and the at least one second audio response over at least a part of the predetermined frequency range; and
providing the audio signal processing parameters for further processing of the respective channel audio signal.

16. The computing device of claim 15, wherein obtaining the at least one first audio response and the at least one second audio response comprises:
obtaining, based on a first channel audio signal output by at least a first speaker of the plurality of speakers, a respective first channel audio response at each of the first listening position and the second listening position; and
obtaining, separately from first channel audio responses, based on a second channel audio signal output by at least a second speaker of the plurality of speakers, a respective second channel audio response at each of the first listening position and the second listening position,
combining the respective first channel audio response and the respective second channel audio response at the first listening position, in order to generate the at least one first audio response; and
combining the respective first channel audio response and respective second channel audio response at the second listening position, in order to generate the at least one second audio response;
wherein determining the audio signal processing parameters is further performed using the first channel audio signal output and the second channel audio signal output at each of the first listening position and the second listening position.

17. The computing device of claim 15, wherein the at least one first audio response and the at least one second audio response comprise one or more of:
a magnitude response in a frequency domain;
a phase response in the frequency domain; or
an impulse response in a time domain.

18. The computing device of claim 15, wherein the similarity metric represents a degree of a similarity between the at least one first audio response and the at least one second audio response.

19. The computing device of claim 15, wherein the steps further comprise:
obtaining at least one third audio response at a third listening position of the plurality of listening positions, the third listening position being different from the first listening position and the second listening position; and
determining the audio signal processing parameters based on a similarity metric calculated between the at least one first audio response, the at least one second audio response, and the at least one third audio response, over at least a part of the predetermined frequency range;
wherein the similarity metric comprises an accumulated similarity metric based on a combination of pair-wise calculated similarity metrics calculated between unique pairs of the at least one first audio response, the at least one second audio response, and the at least one third audio response.

20. The computing device of claim 15, wherein the steps further comprise:
obtaining at least one third audio response at a third listening position of the plurality of listening positions different from the first listening position and the second listening position; and
determining the audio signal processing parameters based on a similarity metric calculated between the at least one first audio response, the at least one second audio response, and the at least one third audio response, over at least a part of the predetermined frequency range;
wherein the similarity metric comprises an accumulated similarity metric based on a combination of pair-wise calculated similarity metrics calculated between unique pairs of the at least one first audio response, the at least one second audio response, and the at least one third audio response.
